(19) United States
(12) Patent Application Publication
(10) Pub. No.: US 2017/0316493 A1
(43) Pub. Date: Nov. 2, 2017

(54) INFORMATION PROCESSING DEVICE AND METHOD, PROGRAM, AND INFORMATION PROCESSING SYSTEM

(71) Applicant: FELICA NETWORKS, INC., TOKYO (JP)

(72) Inventor: TAKUYA NUMATA, KANAGAWA (JP)

(21) Appl. No.: 15/522,888

(22) PCT Filed: Oct. 29, 2015
(86) PCT No.: PCT/JP2015/080486

§ 371 Date: Apr. 28, 2017

(30) Foreign Application Priority Data
Nov. 12, 2014 (JP) 2014-229709

(51) Int. Cl. G06Q 30/06

(52) U.S. Cl. CPC G06Q 30/0645; G06Q 30/0631; G06Q 30/0635

(57) ABSTRACT

The present disclosure relates to an information processing device and a method, a program, and an information processing system that are designed to enhance the convenience of lending services. Information related to lending in a lending service of lending out an object is acquired from another information processing device. Information to be presented to a user is generated with the use of the acquired lending-related information, the information to be presented to the user being related to the lending service. The generated information to be presented to the user is then output. The present disclosure can be applied to information processing devices, for example.

### TECHNICAL FIELD

The present disclosure relates to information processing devices and methods, programs, and information processing systems, and more particularly, to an information processing device and a method, a program, and an information processing system that are designed to enhance the convenience of lending services.

### BACKGROUND ART

A lending service of lending books to users is normally provided at a library. To enhance the convenience of such lending services, information processing systems for providing aid in book lending services have been developed in recent years (see Patent Document 1, for example).

### CITATION LIST

### Patent Document

Patent Document 1: Japanese Patent Application Laid-Open No. 2010-165157

### SUMMARY OF THE INVENTION

### Problems to be Solved by the Invention

However, it is difficult to enhance the convenience of a lending service with a conventional information processing system. For example, Patent Document 1 discloses a method of managing the book lending statuses in a library server, and transmitting e-mail to prompt a user to return a book that has not been returned. However, e-mail might cause a long time lag before the user reads the mail, or might not even reach the user. This reduces the effect (benefit) of the reminder, and the returning of the book is likely to be delayed. As a result, the convenience of the book lending service might be reduced.

The present disclosure is made in view of those circumstances, and aims to enhance the convenience of lending services.

### Solutions to Problems

One aspect of the present technology lies in an information processing device that includes: an acquisition unit that acquires information from another information processing device, the information being related to lending in a lending service of lending out an object; a generation unit that generates information to be presented to a user by using the lending-related information acquired by the acquisition unit, the information to be presented to the user being related to the lending service; and an output unit that outputs the information generated by the generation unit and to be presented to the user.

The output unit may output the information to be presented to the user, without a request of the user.

The information processing device may further include a storage unit that stores the lending-related information acquired by the acquisition unit, and the generation unit may generate the information to be presented to the user, using the lending-related information stored in the storage unit.

The information to be presented to the user may include check-out information indicating the object currently lent to the user.

The information to be presented to the user may include check-out history information indicating the user's history of usage of the lending service.

The information to be presented to the user may include return notification information prompting returning of the object currently lent out.

The information to be presented to the user may include recommendation notification information recommending the predetermined object.

The information processing device may further include a purchasing unit that performs processing related to purchasing of the object, in accordance with the recommendation notification information.

The information processing device may further include a reservation unit that performs processing related to reservation of the object, in accordance with the recommendation notification information.

The information to be presented to the user may include lendability notification information indicating that the object reserved by the user can be lent out.

The lending-related information may be check-out information about a plurality of users, the check-out information indicating the objects currently lent to the users.

The one aspect of the present technology also lies in an information processing method that includes: acquiring information from another information processing device, the information being related to lending in a lending service of lending out an object; generating information to be presented to a user by using the acquired lending-related information, the information to be presented to the user being related to the lending service; and outputting the generated information to be presented to the user.

The one aspect of the present technology further lies in a program for causing a computer to function as: an acquisition unit that acquires information from another information processing device, the information being related to lending in a lending service of lending out an object; a generation unit that generates information to be presented to a user by using the lending-related information acquired by the acquisition unit, the information to be presented to the user being related to the lending service; and an output unit that outputs the information generated by the generation unit and to be presented to the user.

Another aspect of the present technology lies in an information processing device that includes: an acquisition unit that acquires information related to lending in a lending service of lending out an object; a generation unit that generates information to be presented to a user of another information processing device by using the lending-related information acquired by the acquisition unit, the information to be presented to the user being related to the lending service; and a supply unit that supplies the another information processing device with the information generated by the generation unit and to be presented to the user.

The information to be presented to the user may include return notification information prompting returning of the object currently lent out.

The information to be presented to the user may include recommendation notification information recommending the predetermined object.

The information to be presented to the user may include lendability notification information indicating that the object reserved by the user can be lent out.

The information processing device may further include a storage unit that stores the lending-related information, and the acquisition unit may acquire the lending-related information from the storage unit.

Yet another aspect of the present technology lies in an information processing system that includes a server and a terminal device. The server includes: a first acquisition unit that acquires information related to lending in a lending service of lending out an object; a first generation unit that generates recommendation notification information recommending the predetermined object, using the lending-related information acquired by the first acquisition unit; and a supply unit that supplies the terminal device with the recommendation notification information generated by the first generation unit. The terminal device includes: a second acquisition unit that acquires the recommendation notification information from the server; a second generation unit that generates information to be presented to a user, using the recommendation notification information acquired by the second acquisition unit; and an output unit that outputs the information generated by the second generation unit and to be presented to the user.

In one aspect of the present technology, information related to lending in a lending service of lending out an object is acquired from another information processing device. Information to be presented to a user is generated with the use of the acquired lending-related information, the information to be presented to the user being related to the lending service. The generated information to be presented to the user is then output.

In another aspect of the present technology, information related to lending in a lending service of lending out an object is acquired. Information to be presented to the user of another information processing device is generated with the use of the acquired lending-related information, the information to be presented to the user being related to the lending service. The generated information to be presented to the user is then supplied to the other information processing device.

In yet another aspect of the present technology, an information processing system includes a server and a terminal device. In the server, information related to lending in a lending service of lending out an object is acquired, recommendation notification information recommending a predetermined object is generated with the use of the acquired lending-related information, and the generated recommendation notification information is supplied to the terminal device. In the terminal device of the information processing system, the recommendation notification information is acquired from the server, information to be presented to a user is generated with the use of the acquired recommendation notification information, and the generated information to be presented to the user is output.

### Effects of the Invention

According to the present disclosure, information related to lending can be processed. Particularly, the convenience of a lending service can be enhanced.

### BRIEF DESCRIPTION OF DRAWINGS

FIG. 1 is a diagram showing the outline of a book lending service system.

FIG. 2 is a diagram showing a typical example configuration of each device.

FIG. 3 is a functional block diagram showing example functions to be achieved by each device.

FIG. 4 is a functional block diagram showing example functions to be achieved by each device.

FIG. 5 is a flowchart for explaining an example flow of processing related to user registration.

FIG. 6 is a flowchart for explaining an example flow of processing related to lending and returning.

FIG. 7 is a flowchart for explaining an example flow of processing related to viewing of check-out information.

FIG. 8 is a diagram showing examples of display of a check-out information viewing image.

FIG. 9 is a flowchart for explaining an example flow of processing related to viewing of check-out history information and return notification information.

FIG. 10 is a diagram showing examples of display of a check-out history information viewing image.

FIG. 11 is a diagram showing an example of display of a return notification information viewing image.

FIG. 12 is a flowchart for explaining an example flow of processing related to viewing of recommendation notification information.

FIG. 13 is a diagram showing examples of display of a recommendation notification information viewing image.

FIG. 14 is a flowchart for explaining an example flow of processing related to book purchasing.

FIG. 15 is a diagram showing examples of display of a bookselling image.

FIG. 16 is a flowchart for explaining an example flow of processing related to viewing of lendability notification information.

FIG. 17 is a diagram showing examples of display of a lendability notification information viewing image.

FIG. 18 is a diagram showing the outline of a book lending service system.

FIG. 19 is a block diagram showing a typical example configuration of an IC tag.

FIG. 20 is a block diagram showing a typical example configuration of an IC tag reader.

FIG. 21 is a functional block diagram showing example functions to be achieved by each device.

FIG. 22 is a flowchart for explaining an example flow of processing related to lending.

FIG. 23 is a diagram showing an example of display of a check-out reception image.

FIG. 24 is a flowchart for explaining an example flow of processing related to returning.

FIG. 25 is a diagram showing an example of display of a return reception image.

FIG. 26 is a diagram showing the outline of a book lending service system.

FIG. 27 is a functional block diagram showing example functions to be achieved by each device.

FIG. 28 is a flowchart for explaining an example flow of processing related to user registration.

FIG. 29 is a flowchart for explaining an example flow of processing related to user authentication.

### MODES FOR CARRYING OUT THE INVENTION

The following is a description of modes for carrying out the present disclosure (these modes will be hereinafter referred to as embodiments). It should be noted that explanation will be made in the following order.

1. First embodiment (a book lending service system)

2. Second embodiment (a book lending service system)

3. Third embodiment (a book lending service system)

### 1. First Embodiment

<Book Lending Service>

A lending service of lending books to users is normally provided at a library. To enhance the convenience of such lending services, information processing systems for providing aid in book lending services have been developed in recent years.

For example, in a conventional book lending service, returning of a checked-out book might be delayed because the user forgets to return it. When returning is delayed, or before the return due date so as to avoid any delay, the library may remind the user to return the book. Such a reminder is made by post or telephone, for example. However, where such methods are employed, the number of necessary procedures and the costs are large.

Therefore, a method that uses an information processing system has been developed. As disclosed in Patent Document 1, for example, a library server manages the lending statuses of books, and transmits e-mail to the users of unreturned books and prompt returning of those books.

However, e-mail might cause a long time lag before a user reads it. To begin with, e-mail cannot be read by a user, unless the user actively accesses the mail server and download the mail. For example, if the user fails to do so, the e-mail reminder might not even reach the user. In a case where the user registers a less-often-used e-mail address with the system, for example, chances are very low that the user instantly reads the above described e-mail reminder.

If such a reminder does not instantly reach the user, the effect (benefit) of the reminder becomes smaller, and the likelihood of delay in returning the book becomes higher. In a case where an e-mail reminder transmitted earlier than the return due date is read by the user long after the return due date, for example, the user might remain not reminded of the return due date during that period (and the book might not be returned over a long period of time).

There also are cases where the e-mail does not reach the user, for example. The user might register a non-existent e-mail address with the system, for example. Also, the e-mail might not reach the user due to filtering settings in the mail server or the e-mail software.

If the reminder does not reach the user, the delay in returning the book naturally becomes longer.

A user who has failed to return a book by the due date may be subject to punishment. Also, on the library side, it is necessary to remind the user, resulting increases in the number of procedures and the costs. Also, the book might remain unreturned, and be even lost. Furthermore, a user who wishes to borrow the book next might not be able to so until the book is returned. As a result, the book lending service might become less convenient.

Meanwhile, a library server may provide various services by using lending-related information being managed therein. For example, a library server may provide a service usage history (a check-out history) to each user. When a user refers to his/her check-out history, he/she can easily recognize which volumes he/she has read of a publication consisting of multiple volumes, and which volume he/she should borrow next, for example.

In practice, however, after a book is returned, any information related to the lending of the book needs to be erased from the library server to protect personal information, and the check-out history of each user cannot be managed in the server. Therefore, use of lending-related information by a library server is limited to the minimum extent, and, in many cases, it is difficult for a library server to provide a service using lending-related information.

In short, it is difficult to enhance the convenience of a lending service with a conventional information processing system that provides aid in book lending services.

<Use of Information Related to Lending>

In view of the above, a device (a server or a terminal device, for example) outside a library gathers information related to lending from a library server, generates desired information by using the information, and provides a desired service by using the generated information. It should be noted that the term “outside” means “outside the control of the library”, and does not necessarily mean existence physically outside the library (physical locations may be determined as appropriate).

For example, an information processing device includes: an acquisition unit that acquires information from another information processing device, the information being related to lending in a lending service of lending out an object; a generation unit that generates information to be presented to a user by using the lending-related information acquired by the acquisition unit, the information to be presented to the user being related to the lending service; and an output unit that outputs the information generated by the generation unit and to be presented to the user.

That is, an information processing device acquires information from another information processing device, the information being related to lending in a lending service of lending out an object. Using the acquired lending-related information, the information processing device generates information to be presented to a user, the information to be presented to the user being related to the lending service. The information processing device then outputs the generated information to be presented to the user.

In this manner, the user can use a service based on information related to lending, and the convenience of the lending service can be enhanced.

Alternatively, an information processing device includes: an acquisition unit that acquires information related to lending in a lending service of lending out an object; a generation unit that generates information to be presented to the user of another information processing device by using the lending-related information acquired by the acquisition unit, the information to be presented to the user being related to the lending service; and a supply unit that supplies the other information processing device with the information generated by the generation unit and to be presented to the user, for example.

That is, an information processing device acquires information related to lending in a lending service of lending out an object. Using the acquired lending-related information, the information processing device generates information to be presented to the user of another information processing device, the information to be presented to the user being related to the lending service. The information processing device then supplies the other information processing device with the generated information to be presented to the user.

In this manner, the user can use a service based on information related to lending, and the convenience of the lending service can be enhanced.

Further, in an information processing system that includes a server and a terminal device, the server includes: a first acquisition unit that acquires information related to lending in a lending service of lending out an object; a first generation unit that generates recommendation notification information recommending the predetermined object, using the lending-related information acquired by the first acquisition unit; and a supply unit that supplies the terminal device with the recommendation notification information generated by the first generation unit. The terminal device includes: a second acquisition unit that acquires the recommendation notification information from the server; a second generation unit that generates information to be presented to a user, using the recommendation notification information acquired by the second acquisition unit; and an output unit that outputs the information generated by the second generation unit and to be presented to the user.

That is, in an information processing system, a server acquires information related to lending in a lending service of lending out an object, generates recommendation notification information recommending a predetermined object by using the acquired lending-related information, and supplies the generated recommendation notification information to the terminal device, and a terminal device acquires the recommendation notification information from the server, generates information to be presented to a user by using the acquired recommendation notification information, and outputs the generated information to be presented to the user.

In this manner, the user can use a service based on information related to lending, and the convenience of the lending service can be enhanced.

It should be noted that, in the above information processing device or terminal device, the output unit may output the information to be presented to the user, without a request of the user. In this manner, the information to be presented to the user may be output as a push notification, and the user can be notified of the information without fail. Thus, the effect of the information notification can be increased. Also, the trouble the user has to take to receive the information notification can be reduced.

Also, the information processing device may further include a storage unit that stores the lending-related information acquired by the acquisition unit. In that case, the generation unit may generate the information to be presented to the user, using the lending-related information stored in the storage unit. In this manner, the information processing device or the terminal device can generate the information to be presented to the user at any appropriate time. That is, the information processing device or the terminal device can generate information to be presented to various users from the lending-related information, and provide the information to the users.

<Book Lending Service System>

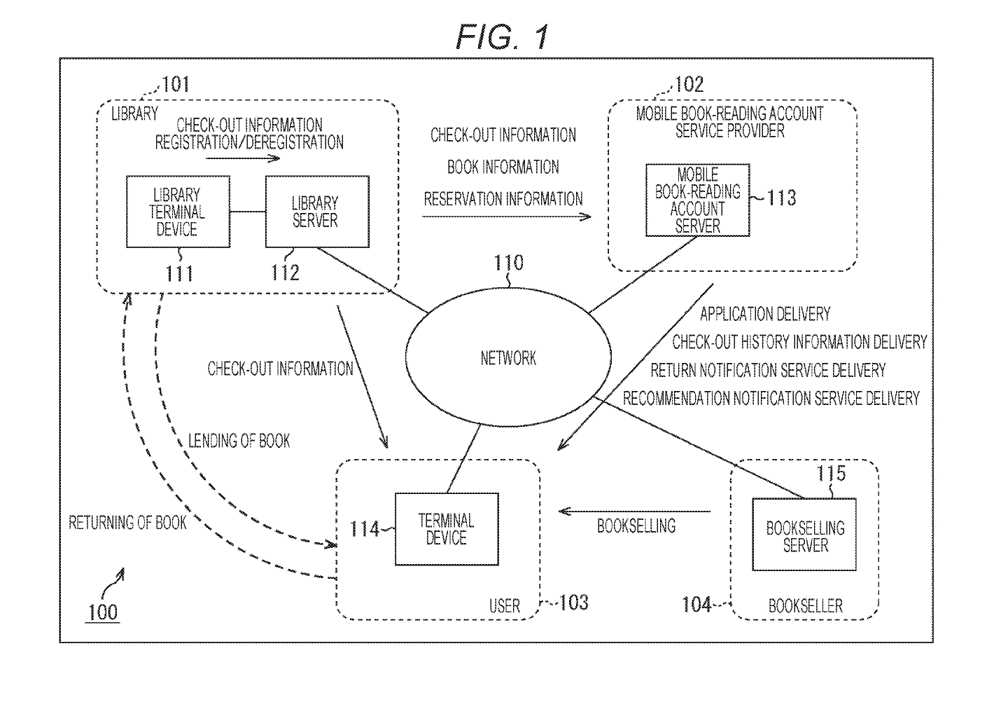

FIG. 1 is a diagram for explaining the outline of a book lending service system that is an embodiment of an information processing system to which the present technology is applied.

The book lending service system 100 shown in FIG. 1 is a system that provides aid in a lending service to be provided by a library 101 to lend out books (published books). The library 101 provides a book lending service to a user 103. A mobile book-reading account service provider 102 provides the user 103 with a service (a mobile book-reading account service) related to the book lending service being provided by the library 101. For example, the mobile book-reading account service provider 102 provides the user 103 with an application dealing with various kinds of information related to book lending, or provides the user 103 with various kinds of information related to book lending. The user 103 uses the book lending service being provided by the library 101, various services being provided by the mobile book-reading account service provider 102, and a bookselling service being provided by a bookseller 104. The bookseller 104 provides the bookselling service to the user 103.

As shown in FIG. 1, the library 101 has a library terminal device 111 and a library server 112. The library terminal device 111 is a terminal device to be operated by a librarian, and is connected to the library server 112 via a predetermined network in such a manner as to be able to communicate with the library server 112. The library terminal device 111 receives inputs of information or the like about lending and returning of books (published books). The library terminal device 111 supplies the received information to the library server 112. That is, the library terminal device 111 performs processing related to registration and deregistration of check-out information being managed by the library server 112, for example. The check-out information will be described later.

The library server 112 manages information related to lending in the book lending service. For example, the library server 112 manages the information about the users of the book lending service as the information related to lending. This user information includes the identification information (such as the membership number (ID)) about the user 103, for example. The user information may of course include information other than the above. For example, the user information may include various kinds of personal information, such as name, age, gender, occupation, password, address, telephone number, and e-mail address. Also, the user information may include information (of the same user, for example) that is to be associated with the user information and is related to the information about the user of the service (the mobile book-reading account service) being provided by the mobile book-reading account service provider 102 (or the user information about the very user, for example). That is, information indicating the correspondence relationship (association) between the information about a user of the book lending service and the information about the user of the mobile book-reading account service may be included in the information about the user of the book lending service.

The library server 112 can exchange user information with a mobile book-reading account server 113, and associate (link) these sets of information with each other. For example, the library server 112 can link sets of user information about the same user with each other. Information about the correspondence relationship (association) may be included in each set of user information as described above, or may be managed as different information from the user information.

The library server 112 also manages the check-out information about the books that are currently checked out, as the information related to lending. This check-out information includes the name (title) of the checked-out book, the check-out date, the return due date, and the name of the borrowing user, for example. That is, the check-out information includes information indicating which books are lent to which users, when the books were checked out, and by which dates the books are to be returned, for example. The check-out information may of course include any other appropriate information. The check-out information may include more specific information about the books, such as the names of the authors, the names of the publishers, the dates of publication, the international standard book numbers (ISBNs), and summaries.

The library server 112 further manages reservation information about reservations for lending of books. This reservation information includes information, such as the names (titles) of the books for which lending reservations have been made, the names of the users who have made the reservations, the dates for lending, and the current statuses of the books. That is, the reservation information includes information indicating which books are reserved for which users, when the books are to be checked out, and the current statuses of the books, for example. The reservation information may of course include any other appropriate information. For example, the reservation information may include more specific information about the books, such as the names of the authors, the names of the publishers, the dates of publication, the ISBNs, and summaries.

The library server 112 of course manages book information that is the information about all the books as the objects to be lent out in the lending service. This book information includes any appropriate information. For example, the book information may include information, such as the names of the authors of the books, the names of the publishers, the dates of publication, the ISBNs, and summaries.

The library server 112 can also provide other devices with these sets of information being managed therein. For example, the library server 112 can supply the check-out information to the mobile book-reading account server 113 and a terminal device 114. The library server 112 can also supply the book information and the reservation information to the mobile book-reading account server 113, for example.

As shown in FIG. 1, the mobile book-reading account service provider 102 has the mobile book-reading account server 113. The mobile book-reading account server 113 manages information about the users of the mobile book-reading account service, for example. This user information includes the identification information (such as the membership number (ID)) about the user 103, for example. The user information may of course include information other than the above. For example, the user information may include various kinds of personal information, such as name, age, gender, occupation, password, address, telephone number, and e-mail address. The user information may also include information (of the same user, for example) that is to be associated with the user information and is related to the information about the user of the book lending service. That is, information indicating the correspondence relationship (association) between the information about a user of the book lending service and the information about the user of the mobile book-reading account service may be included in the information about the user of the mobile book-reading account service.

The mobile book-reading account server 113 can exchange user information with the library server 112, and associate (link) these sets of information with each other. For example, the mobile book-reading account server 113 can link sets of user information about the same user with each other. Information about the correspondence relationship (association) may be included in each set of user information as described above, or may be managed as different information from the user information.

The mobile book-reading account server 113 can also provide the terminal device 114 with an application dealing with information related to book lending, for example. The mobile book-reading account server 113 can also acquire information related to lending from the library server 112, for example, and provide the user 103 (the terminal device 114) with various services, using the information related to lending. For example, the mobile book-reading account server 113 can acquire check-out information, book information, and reservation information, as the information related to lending.

Using the check-out information about the user 103, the mobile book-reading account server 113 can generate check-out history information that indicates the lending service usage history of the user 103, for example, and provide the check-out history information to the user 103 (the terminal device 114). Using the check-out information, the mobile book-reading account server 113 can also generate return notification information for prompting the user 103 to return the currently checked-out book, and provide the return notification information to the user 103 (the terminal device 114). Using various kinds of information related to lending, the mobile book-reading account server 113 can further generate recommendation notification information for recommending predetermined books to the user 103, and provide the recommendation notification information to the user 103 (the terminal device 114).

As shown in FIG. 1, the user 103 has the terminal device 114. Using various kinds of lending-related information supplied from the library server 112 and the mobile book-reading account server 113, the terminal device 114 generates information that concerns the lending service and is to be presented to the user, and outputs the information to be presented to the user. For example, the terminal device 114 generates and displays the information to be presented to the user, such as a check-out information viewing image that indicates the book(s) currently lent to the user 103, a check-out history information viewing image that indicates the lending service usage history of the user 103, a return notification information viewing image that prompts the user 103 to return the book(s) currently lent to the user 103, a recommendation notification information viewing image that recommends predetermined books, and a lendability notification information viewing image indicating that the book(s) reserved by the user 103 can be lent out.

It should be noted that the terminal device 114 can also reserve a book to be lent out, and purchase a book (a published book).

As shown in FIG. 1, the bookseller 104 has a bookselling server 115. The bookselling server 115 performs processing related to bookselling. For example, the bookselling server 115 receives a book purchase request from the terminal device 114. In a case where the book is in the form of electronic data, the bookselling server 115 may transmit the electronic data to the terminal device 114.

As shown in FIG. 1, the library server 112, the mobile book-reading account server 113, the terminal device 114, and the bookselling server 115 are connected to one another via a network 110. The network 110 is a communication network that serves as a communication medium. The network 110 may be any communication network, such as a cable communication network or a wireless communication network, or may include both a cable communication network and a wireless communication network. For example, the network 110 may be a cable local area network (LAN), a wireless LAN, a public telephone network, a wide-area communication network for wireless mobile terminals, such as a so-called 3G network or a 4G network, the Internet, or a combination of some of these networks. Also, the network 110 may be a single communication network, or may be formed with multiple communication networks. Also, part of or all of the network 110 may be formed with communication cables compliant with predetermined standards, such as universal serial bus (USB, a registered trade name) cables or high-definition multimedia interface (HDMI, a registered trade name) cables. Further, part of or all of the network 110 may be formed according to a method compliant with predetermined standards such as the ad-hoc mode of the Institute of Electrical and Electronic Engineers (IEEE) 802.11 (a registered trade name) wireless LAN, optical communication with infrared rays or the like compliant with InfraRed Data Association (IrDA) (a registered trade name), or Bluetooth (a registered trade name), or may be formed by wireless communication according to an original communication method.

The library server 112, the mobile book-reading account server 113, the terminal device 114, and the bookselling server 115 exchange (transmit and receive) various kinds of information via the network 110.

It should be noted that, although the library 101, the mobile book-reading account service provider 102, the user 103, and the bookseller 104 are as single components shown in FIG. 1, the numbers of these components may be determined as appropriate, and may be two or greater.

Also, in FIG. 1, the library terminal device 111, the library server 112, the mobile book-reading account server 113, the terminal device 114, and the bookselling server 115 are shown as single components. However, the numbers of these components may be determined as appropriate, and may be two or greater.

<Physical Configuration of Each Device>

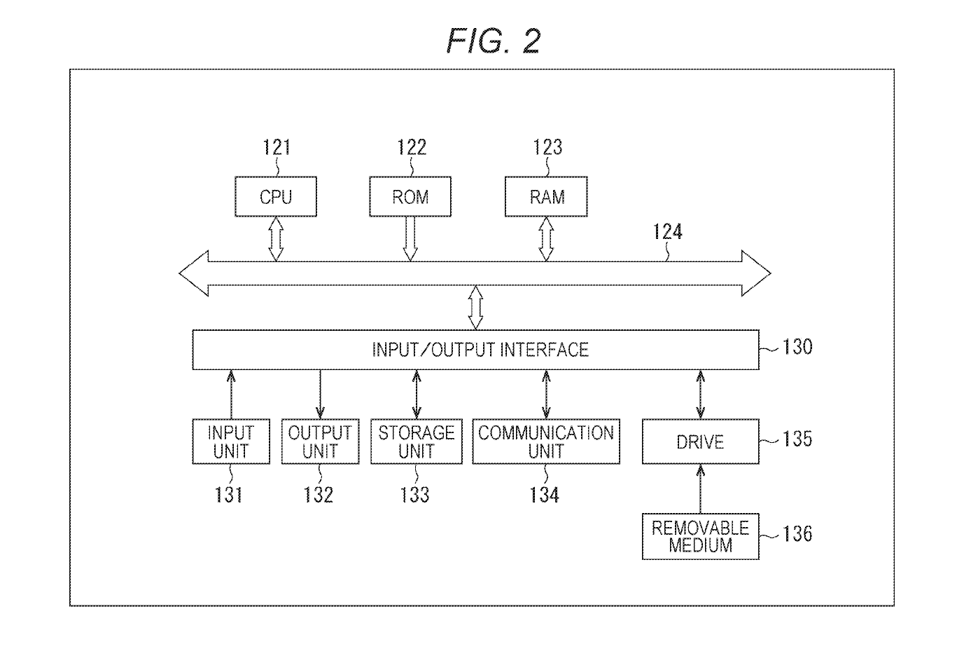

Next, an example configuration of each of the following devices, the library terminal device 111, the library server 112, the mobile book-reading account server 113, the terminal device 114, and the bookselling server 115, is described. FIG. 2 is a block diagram showing a typical example configuration of each of these devices.

As shown in FIG. 2, in each device, a central processing unit (CPU) 121, a read only memory (ROM) 122, and a random access memory (RAM) 123 are connected to one another via a bus 124.

An input/output interface 130 is also connected to the bus 124. An input unit 131, an output unit 132, a storage unit 133, a communication unit 134, and a drive 135 are connected to the input/output interface 130.

The input unit 131 is formed with an input device that receives external information such as user inputs. The input unit 131 includes a keyboard, a mouse, operation buttons, a touch panel, a camera, a microphone, and an input terminal, for example. The input unit 131 may also include various sensors such as an acceleration sensor, an optical sensor, and a temperature sensor, and an input machine such as a bar code reader.

The output unit 132 is formed with an output device that outputs information such as images and sound. The output unit 132 includes a display, a speaker, and an output terminal, for example.

The storage unit 133 is formed with a hard disk, a RAM disk, a nonvolatile memory, or the like. The communication unit 134 is formed with a network interface or the like. For example, the communication unit 134 is connected to the network 110, and communicates with the other devices connected via the network 110. The drive 135 drives a removable medium 136 that is a magnetic disk, an optical disk, a magnetooptical disk, a semiconductor memory, or the like and is mounted in a predetermined location therein. By doing so, the drive 135 reads information stored in the removable medium 136, or writes information into the removable medium 136.

The CPU 121 loads a program stored in the storage unit 133 into the RAM 123 via the input/output interface 130 and the bus 124, and executes the program, to perform various processes. The RAM 123 also stores data and the like necessary for the CPU 121 to perform various processes as appropriate.

The program to be executed by the CPU 121 may be recorded on the removable medium 136 as a packaged medium or the like, and be then provided. In that case, the program may be installed into the storage unit 133 via the input/output interface 130 when the removable medium 136 is mounted on the drive 135.

Alternatively, this program may be provided via a wired or wireless transmission medium such as a LAN, the Internet, or digital satellite broadcasting. In that case, the program may be received by the communication unit 134 via a wired or wireless transmission medium (the network 110, for example), and be then installed into the storage unit 133.

Also, this program may be installed beforehand into the ROM 122 or the storage unit 133.

The library server 112, the mobile book-reading account server 113, the terminal device 114, and the bookselling server 115 each have the configuration shown in FIG. 2. That is, the above explanation made with reference to FIG. 2 can also be an explanation of each of these devices.

<Configurations of Functional Blocks>

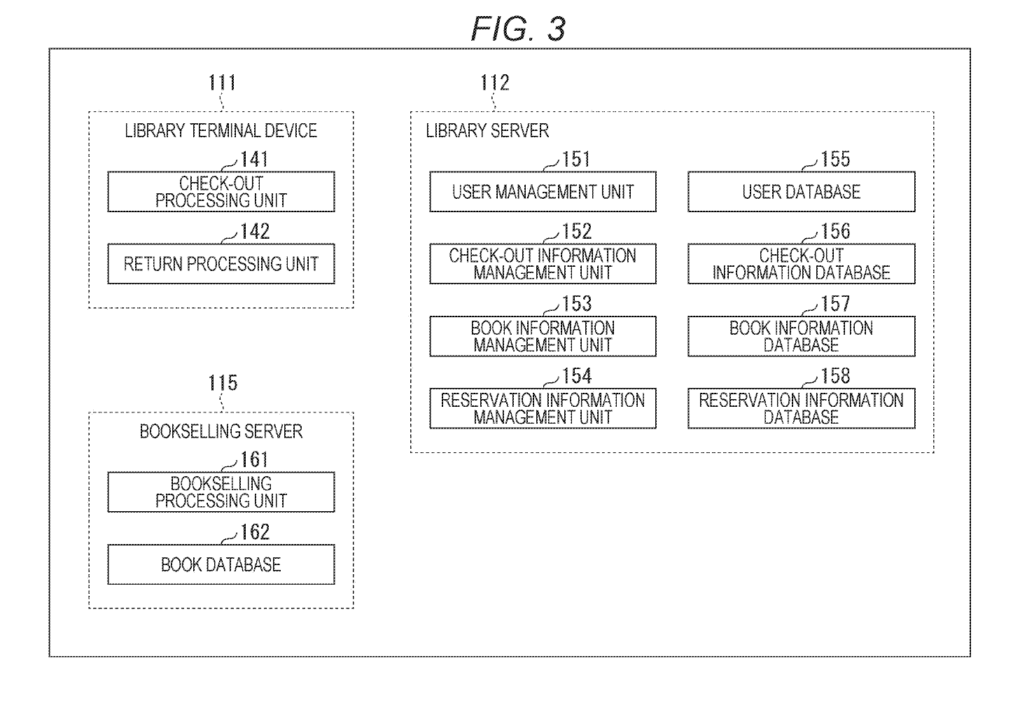

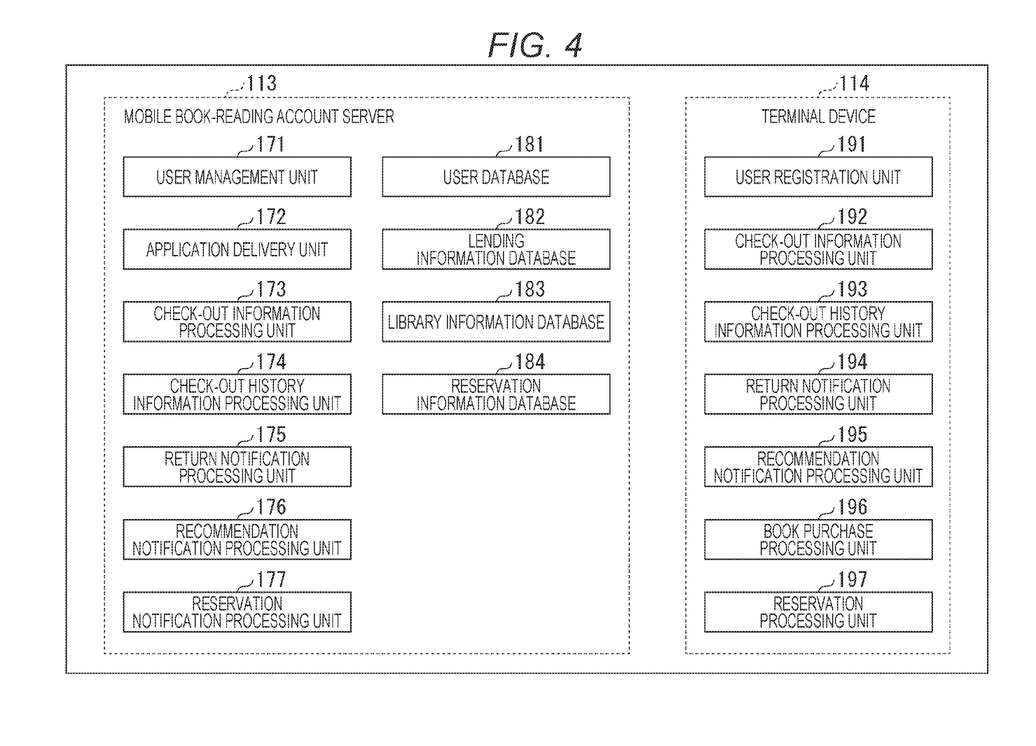

Next, the functions to be achieved by the respective devices of the library server 112, the mobile book-reading account server 113, the terminal device 114, and the bookselling server 115 are described. FIGS. 3 and 4 are functional block diagrams showing typical example functions to be achieved by the respective devices.

As shown in FIG. 3, the library terminal device 111 forms functional blocks such as a check-out processing unit 141 and a return processing unit 142. The check-out processing unit 141 performs processing related to lending of a book. The return processing unit 142 performs processing related to returning of a book. As the CPU 121 of the library terminal device 111 executes a program, these functions are achieved.

Meanwhile, the library server 112 forms functional blocks such as a user management unit 151, a check-out information management unit 152, a book information management unit 153, a reservation information management unit 154, a user database 155, a check-out information database 156, a book information database 157, and a reservation information database 158.

The user management unit 151 performs processing related to management of book lending service user information, using the user database 155. The check-out information management unit 152 performs processing related to management of check-out information, using the check-out information database 156. The book information management unit 153 performs processing related to management of book information, using the book information database 157. The reservation information management unit 154 performs processing related to management of reservation information, using the reservation information database 158. As the CPU 121 of the library server 112 executes a program, these functions are achieved.

The user database 155 stores user information. The check-out information database 156 stores check-out information. The book information database 157 stores book information. The reservation information database 158 stores reservation information. These databases are formed in the storage unit 133 of the library server 112.

Further, the bookselling server 115 forms functional blocks such as a bookselling processing unit 161 and a book database 162. The bookselling processing unit 161 performs processing related to selling of books (published books). As the CPU 121 of the bookselling server 115 executes a program, these functions are achieved. The book database 162 stores information about the books for sale. This information about the books is used by the bookselling processing unit 161 to perform the processing related to bookselling. This database is formed in the storage unit 133 of the bookselling server 115.

It should be noted that this information related to the books may include the electronic data of the books. That is, the bookselling processing unit 161 may sell the electronic data of the books stored in the book database 162.

As shown in FIG. 4, the mobile book-reading account server 113 forms functional blocks such as a user management unit 171, an application delivery unit 172, a check-out information processing unit 173, a check-out history information processing unit 174, a return notification processing unit 175, a recommendation notification processing unit 176, a reservation notification processing unit 177, a user database 181, a lending information database 182, a book information database 183, and a reservation information database 184.

The user management unit 171 performs processing related to management of mobile book-reading account service user information, using the user database 181. The application delivery unit 172 performs processing related to delivery of an application dealing with information related to book lending. The check-out information management unit 173 performs processing related to acquisition of check-out information. The check-out history information processing unit 174 performs processing related to check-out history information, using the lending information database 182. The return notification processing unit 175 performs processing related to return notification information, using the lending information database 182. The recommendation notification processing unit 176 performs processing related to book recommendations, using the lending information database 182 and the book information database 183. The reservation notification processing unit 177 performs processing related to reservation notification information, using the reservation information database 184. As the CPU 121 of the mobile book-reading account server 113 executes a program, these functions are achieved.

The user database 181 stores mobile book-reading account service user information. The lending information database 182 stores lending information. This lending information includes check-out information acquired from the library server 112 and check-out history information generated by the check-out history information processing unit 174. The book information database 183 stores book information acquired from the library server 112. The reservation information database 184 stores reservation information acquired from the library server 112. These databases are formed in the storage unit 133 of the mobile book-reading account server 113.

Meanwhile, the terminal device 114 forms functional blocks such as a user registration unit 191, a check-out information processing unit 192, a check-out history information processing unit 193, a return notification processing unit 194, a recommendation notification processing unit 195, a book purchase processing unit 196, and a reservation processing unit 197.

The user registration unit 191 performs processing related to registration of book lending service user information and mobile book-reading account service user information. The check-out information processing unit 192 performs processing related to check-out information. The check-out history information processing unit 193 performs processing related to check-out history information. The return notification processing unit 194 performs processing related to return notification information. The recommendation notification processing unit 195 performs processing related to recommendation notification information. The book purchase processing unit 196 performs processing related to purchasing of books (published books). The reservation processing unit 197 performs processing related to book lending reservations. As the CPU 121 of the terminal device 114 executes a program (an application supplied from the mobile book-reading account server 113, for example), these functions are achieved.

<Flow of Processing Related to User Registration>

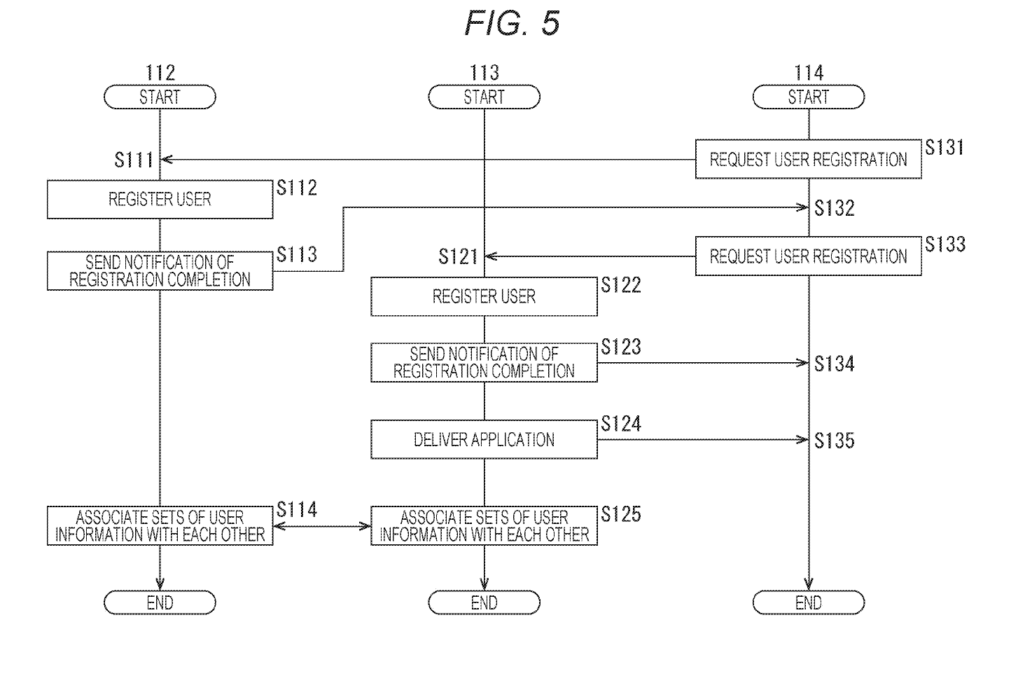

Next, flows in various processes to be performed by the book lending service system 100 shown in FIG. 1 are described. Referring now to the flowchart in FIG. 5, the flow of processing related to registration of book lending service user information and mobile book-reading account service user information is described.

In a case where a user is to be registered for the book lending service, the user registration unit 191 of the terminal device 114 transmits and supplies the information necessary for the user registration to the library server 112 through the communication unit 134 of the terminal device 114, and requests the user registration in step S131. In step S111, the user management unit 151 of the library server 112 obtains the information through the communication unit 134 of the library server 112. In step S112, using the obtained information, the user management unit 151 generates user information about the user 103, and registers the user information in the user database 155. When the registration is completed, the user management unit 151 of the library server 112 notifies the terminal device 114 of the completion of the user registration through the communication unit 134 of the library server 112 in step S113. In step S132, the user registration unit 191 of the terminal device 114 receives the notification through the communication unit 134 of the terminal device 114.

Meanwhile, in a case where the user is to be registered for the mobile book-reading account service, the user registration unit 191 of the terminal device 114 transmits and supplies the information necessary for the user registration to the mobile book-reading account server 113 through the communication unit 134 of the terminal device 114, and requests the user registration in step S133. In step S121, the user management unit 171 of the mobile book-reading account server 113 obtains the information through the communication unit 134 of the mobile book-reading account server 113. In step S122, using the obtained information, the user management unit 171 generates user information about the user 103, and registers the user information in the user database 181. When the registration is completed, the user management unit 171 of the mobile book-reading account server 113 notifies the terminal device 114 of the completion of the user registration through the communication unit 134 of the mobile book-reading account server 113 in step S123. In step S134, the user registration unit 191 of the terminal device 114 receives the notification through the communication unit 134 of the terminal device 114.

When the user registration for the mobile book-reading account service is completed, the application delivery unit 172 of the mobile book-reading account server 113 in step S124 transmits and supplies an application dealing with various kinds of information related to book lending, to the terminal device 114 through the communication unit 134 of the mobile book-reading account server 113 at a predetermined time. In step S135, the user registration unit 191 of the terminal device 114 obtains the application through the communication unit 134 of the terminal device 114. The obtained application is installed into the storage unit 133.

When the user registration is completed in both the book lending service and the mobile book-reading account service, the user management unit 151 of the library server 112 and the user management unit 171 of the mobile book-reading account server 113 exchange information with each other through the respective communication units 134, and link (associate) the sets of user information with each other (step S114 and step S125). For example, the user management unit 151 and the user management unit 171 associate the sets of user information about the same user with each other.

In the above manner, user registration for the book lending service and the mobile book-reading account service is conducted. With this, user registration can be more readily conducted. Also, sets of user information in both services can be more easily linked with each other. Thus, the convenience of the lending service can be enhanced.

<Flow of Processing Related to Lending and Returning of a Book>

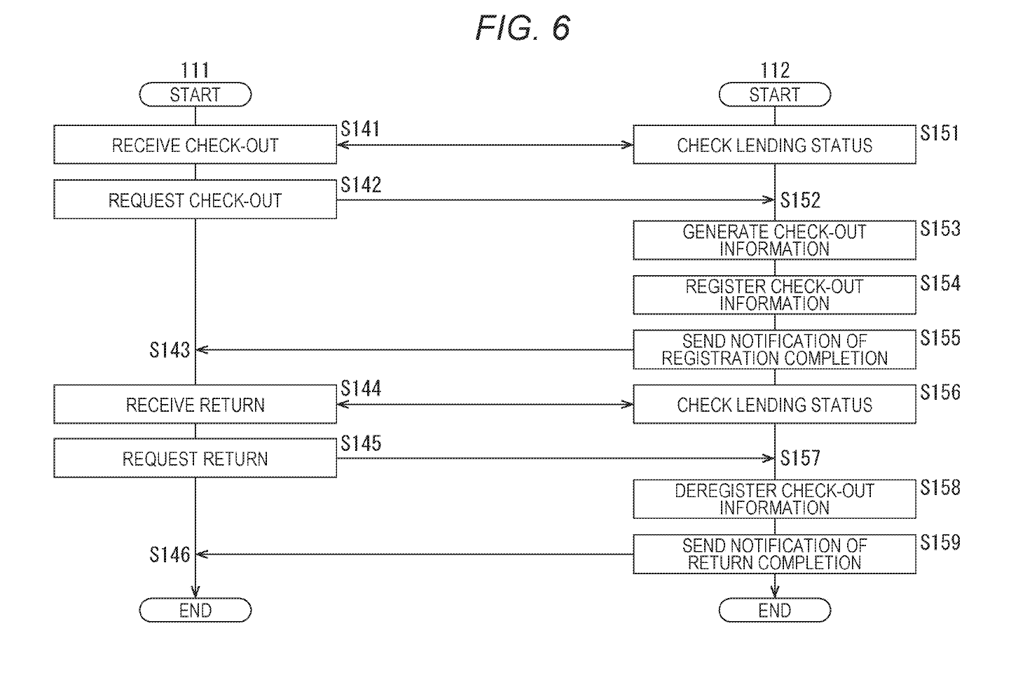

Referring now to the flowchart in FIG. 6, the flow of processing related to lending and returning of a book is described.

In a case where a book is to be lent out, a staff member at the library 101 carries out the procedure for lending the book to the user 103, and inputs information to that effect to the library terminal device 111. In step S141, the check-out processing unit 141 of the library terminal device 111 receives the input (or receives a check-out input) through the input unit 131. At this point, the check-out processing unit 141 controls the check-out information management unit 152 of the library server 112 through the communication unit 134, to cause the check-out information management unit 152 to refer to the check-out information and check the lending status of the book (or determine whether the book can be lent out) (step S151).

If the book can be lent out, the check-out processing unit 141 of the library terminal device 111 requests the library server 112 to lend out the book, through the communication unit 134 of the library terminal device 111 (step S142 and step S152).

In accordance with the request, the check-out information management unit 152 of the library server 112 generates the check-out information about the book requested to be lent out (step S153), registers the check-out information in the check-out information database 156 (step S154), and notifies the library terminal device 111 of the completion of the check-out procedure through the communication unit 134 of the library server 112 (step S155 and step S143).

Meanwhile, in a case where a borrowed book is to be returned, a staff member at the library 101 carries out the procedure for returning of the book from the user 103, and inputs information to that effect to the library terminal device 111. In step S144, the return processing unit 142 of the library terminal device 111 receives the input (or receives a return) through the input unit 131. At this point, the return processing unit 142 controls the check-out information management unit 152 of the library server 112 through the communication unit 134, to cause the check-out information management unit 152 to refer to the check-out information and check the lending status of the book (or determine whether the book can be returned) (step S156).

If the book can be returned, the return processing unit 142 of the library terminal device 111 sends the library server 112 a request for a return of the book, through the communication unit 134 of the library terminal device 111 (step S145 and step S157).

In accordance with the request, the check-out information management unit 152 of the library server 112 deregisters (erases) the check-out information about the book requested to be returned (step S158), and notifies the library terminal device 111 of the completion of the return procedure through the communication unit 134 of the library server 112 (step S159 and step S146).

In the above manner, processing related to lending and returning of a book is performed. Accordingly, check-out information can be more readily generated and deregistered. That is, check-out information can be more easily managed. Thus, the convenience of the lending service can be enhanced.

<Flow of Processing Related to Viewing of Check-Out Information>

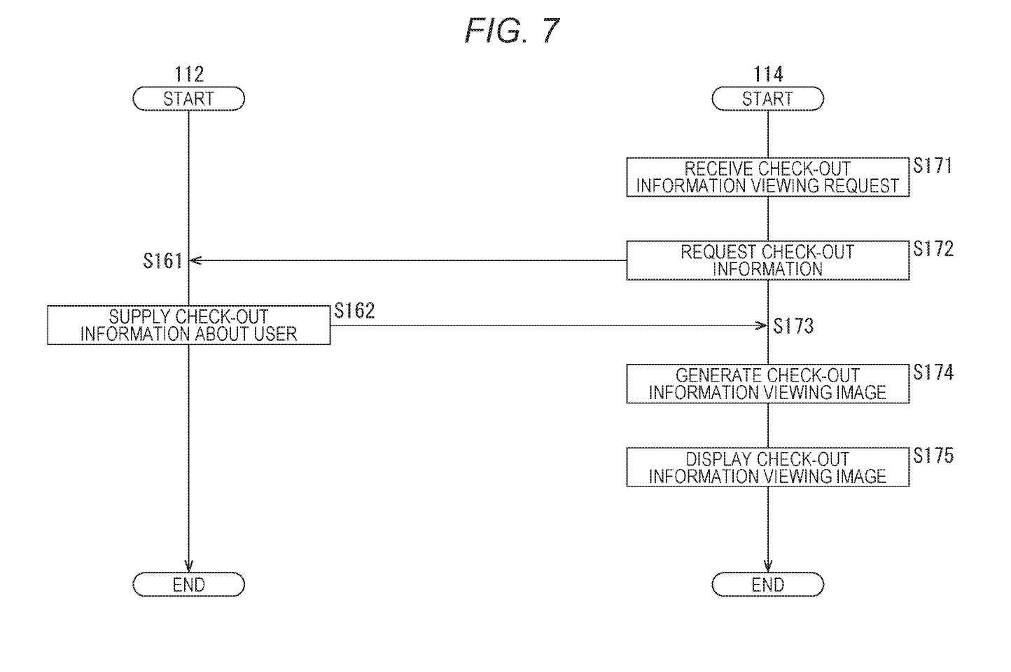

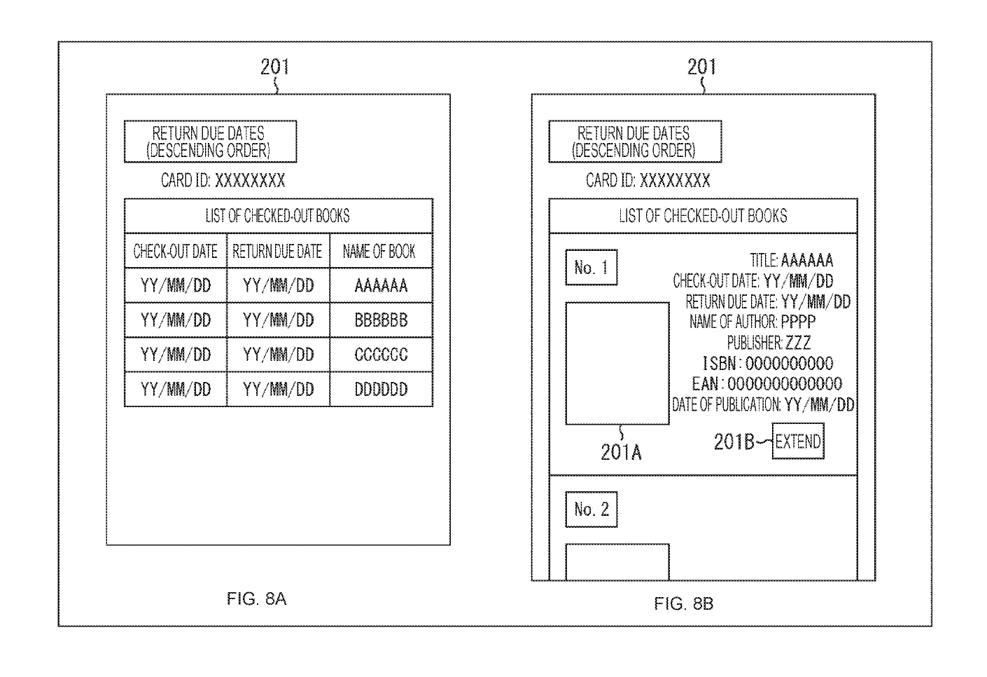

Referring now to the flowchart in FIG. 7, the flow of processing related to viewing of check-out information is described. The explanation will also be made with reference to FIG. 8 as necessary.

The check-out information that is the information related to the book(s) currently lent to a user is managed in the library server 112. The terminal device 114 acquires the check-out information about the user 103 from the library server 112, and generates the information to be presented to the user 103. The information to be presented to the user 103 is a check-out information viewing image that includes the contents of the acquired check-out information and indicates the currently checked-out book(s) to the user 103. The terminal device 114 displays the check-out information viewing image.

The terminal device 114 performs such processing, using an application that has been acquired from the mobile book-reading account server 113 and been installed. Thus, the user 103 can more easily view the check-out information about himself/herself, without any communication settings or generation of an image for display, for example. That is, the user 103 can more easily recognize the book(s) currently lent to himself/herself. With this, the user 103 can prevent himself/herself from forgetting to return a book. By referring to the check-out information, the user 103 can also prevent himself/herself from making a mistake such as borrowing the same book as one currently lent to himself/herself. Thus, the convenience of the lending service can be enhanced.

As the image for viewing can be generated in the terminal device 114 in the above manner, an increase in the load on the library server 112 can also be prevented. Thus, the library server 112 can perform other processing by a larger amount and at a higher speed. By virtue of these aspects, the convenience of the lending service can be enhanced.

A specific example of the flow of the processing is described below. As shown in FIG. 7, the check-out information processing unit 192 of the terminal device 114 receives a check-out information viewing request through the input unit 131 of the terminal device 114, for example (step S171), and then requests the check-out information about the user 103 from the library server 112 through the communication unit 134 of the terminal device 114 (step S172).

Acquiring the request through the communication unit 134 of the library server 112 (step S161), the check-out information management unit 152 of the library server 112 acquires the requested check-out information about the user 103 from the check-out information database 156, and supplies the acquired check-out information to the terminal device 114 as the requester through the communication unit 134 of the library server 112 (step S162).

Acquiring the check-out information through the communication unit 134 of the terminal device 114 (step S173), the check-out information processing unit 192 of the terminal device 114 generates a check-out information viewing image that is an image for displaying the acquired check-out information (step S174). The check-out information processing unit 192 of the terminal device 114 then causes the output unit 132 (a display) to display the generated check-out information viewing image (step S175).

Through this processing, the user 103 can view the check-out information viewing image displayed on the terminal device 114.

It should be noted that this check-out information can also be managed in the mobile book-reading account server 113, as will be described later in detail. In that case, the terminal device 114 may be designed to acquire the check-out information about the user 103 from the mobile book-reading account server 113. That is, the mobile book-reading account server 113 may be designed to provide a check-out information delivery service as a mobile book-reading account service. In this case, the only difference from the case shown in FIG. 7 is the transmitter of the check-out information, and thus, the convenience of the lending service can be enhanced as in the case shown in FIG. 7.

FIG. 8 shows examples of display of a check-out information viewing image. In the example cases shown in FIG. 8, a check-out information viewing image 201 includes a list of the books currently lent to the user 103 (a checked-out book list), information indicating the order in the checked-out book list, and the identification information (card ID) about the user 103.

Any appropriate information can be displayed in the checked-out book list, as long as the information is related to a book currently lent to the user 103. For example, in the case shown in A of FIG. 8, only text information related to the books is displayed in the checked-out book list. More specifically, the check-out dates of the books, the return due dates, the titles, and the like are displayed. In this manner, information about more books than in the example shown in B of FIG. 8 can be displayed at once. Information other than the above may of course be included in the checked-out book list. For example, the check-out information may include the names of the authors, the names of the publishers, the dates of publication, the ISBNs, and summaries. As such information is displayed, the user 103 can more easily recognize the books currently lent to himself/herself. That is, the convenience of the lending service can be enhanced.

In the example case shown in B of FIG. 8, on the other hand, image information 201A such as the front cover of a book is displayed in the checked-out book list. Although this image information 201A is represented by a blank square in B of FIG. 8, an image such as the front cover of the book is displayed in this blank square in reality. With this display, the user 103 can more instinctively recognize the books currently lent to himself/herself. That is, the convenience of the lending service can be enhanced.

Also, in this case, text information about the books, such as the names of the authors, the publishers, the ISBNs, the European Article Numbers (EANs), and the dates of publication, is more specifically shown in the checked-out book list than in A of FIG. 8. Accordingly, the user 103 can more easily recognize the books currently lent to himself/herself. That is, the convenience of the lending service can be enhanced.

Further, in the example case shown in B of FIG. 8, an extension graphical user interface (GUI) button 201B to be operated by the user 103 to extend a return due date is also displayed. With this, the user 103 can more easily extend the return due date of a checked-out book. For example, the user 103 does not need to visit the library 101, but only has to operate this extension GUI button to extend the return due date of the book in a simpler manner. That is, the convenience of the lending service can be enhanced.

Also, in the cases shown in A of FIG. 8 and B of FIG. 8, “return due dates (descending order)” are displayed as the information indicating the order in the checked-out book list, and show that the order in the checked-out book list is the descending order corresponding to the return due dates. With this, the user 103 can more easily recognize the order in the checked-out book list.

It should be noted that this display showing the order in the checked-out book list may be a GUI that can be operated (tapped, for example) by the user 103 to switch the order to some other kind (or select order). With this, the user 103 can more easily change the order in the checked-out book list. Thus, the user 103 can more easily view the information in the checked-out book list. That is, the convenience of the lending service can be enhanced.

Also, in a case where an entire check-out information viewing image cannot be displayed in the display area of the terminal device 114 at once because the number of the currently checked-out books is large, for example, the check-out information viewing image may be scrolled for display.

Also, the example shown in A of FIG. 8 and the example shown in B of FIG. 8 may be combined. For example, as for the few books appearing at the top of the checked-out book list, more specific information may be displayed as in the example shown in B of FIG. 8. As for the few books appearing at the bottom of the list, less specific information, such as text-only information, may be displayed as in the example shown in A of FIG. 8. Also, the user 103 may be allowed to switch between the example shown in A of FIG. 8 and the example shown in B of FIG. 8 as appropriate. Alternatively, when a book in the checked-out book list in the example shown in A of FIG. 8 is selected, more specific information about the selected book may be displayed as in the example shown in B of FIG. 8. In this manner, viewing of the check-out information becomes easier, and the user 103 can more readily obtain desired information about the currently checked-out books.

<Flow of Processing Related to Viewing of Check-Out History Information>

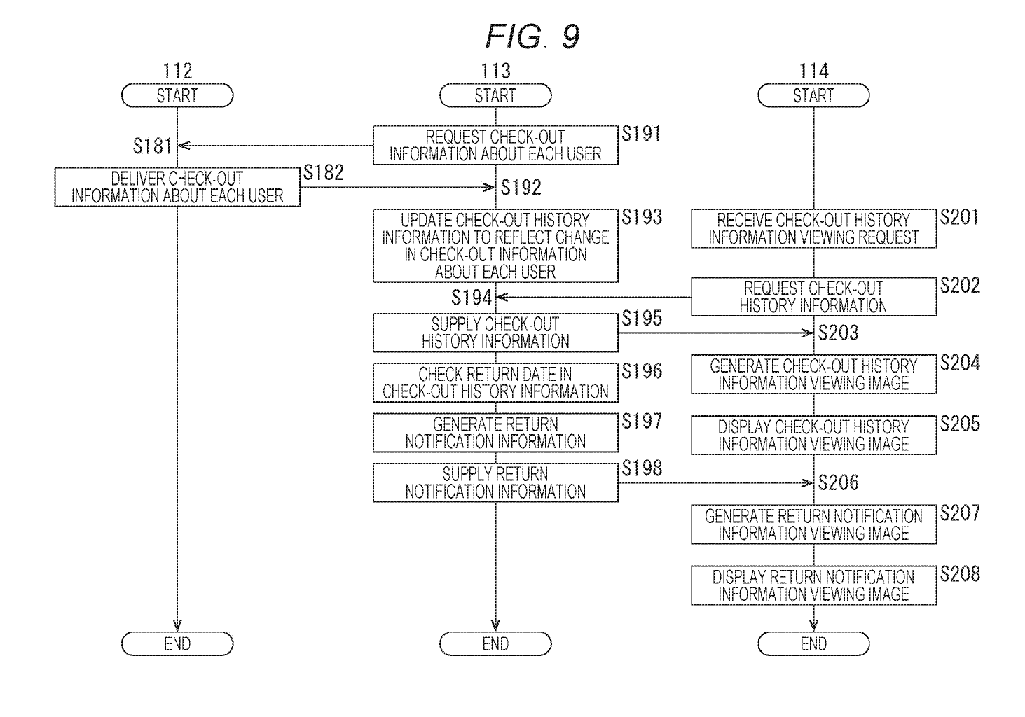

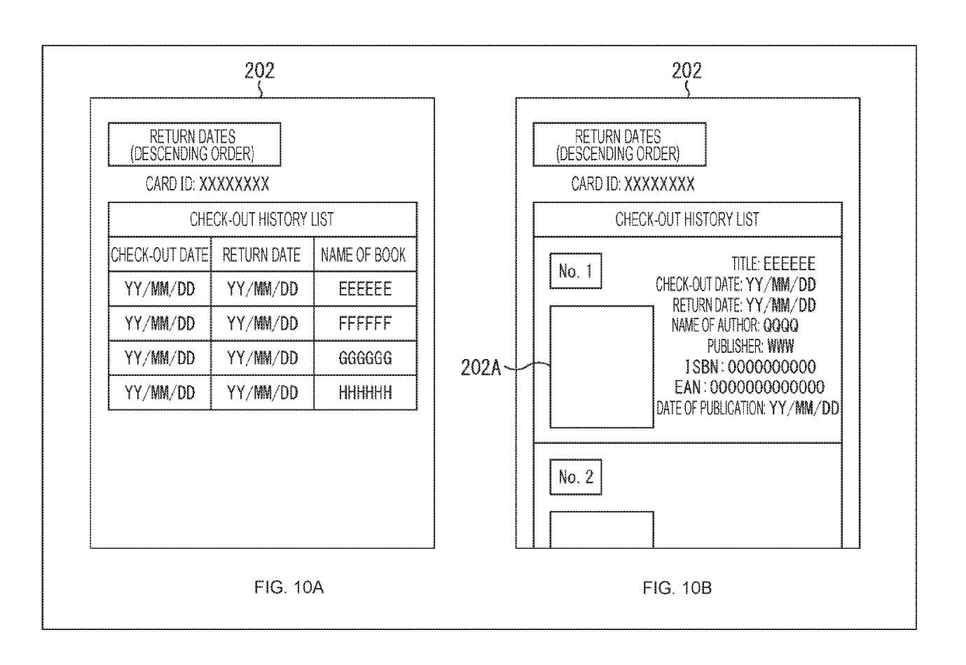

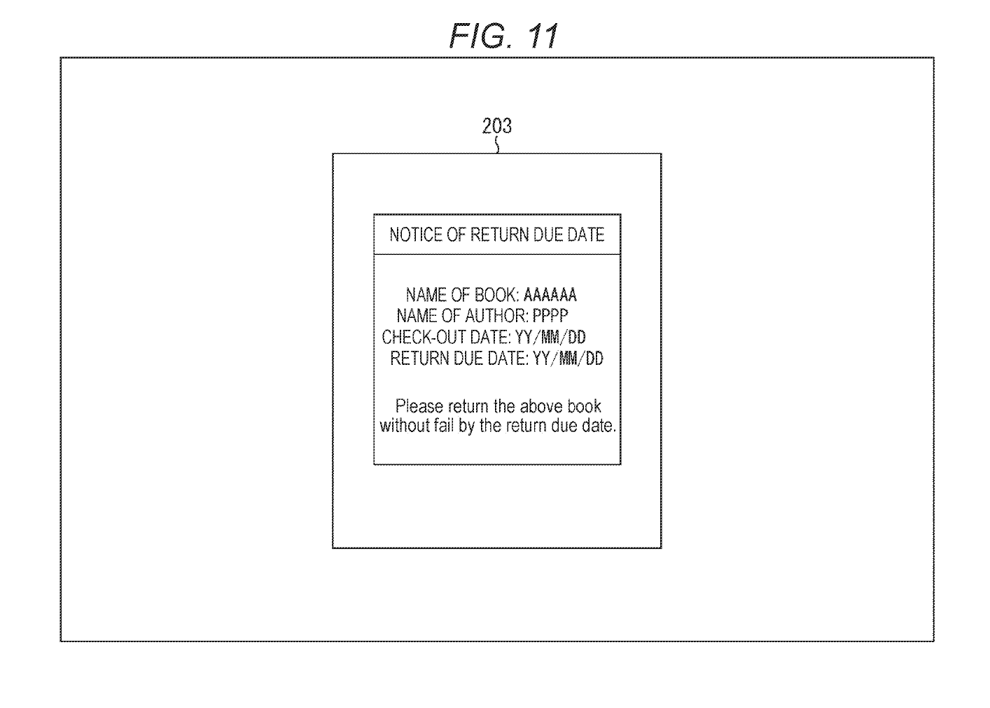

Referring now to the flowchart in FIG. 9, the flow of processing related to viewing of check-out history information is described. The explanation will also be made with reference to FIGS. 10 and 11 as necessary.

At the library 101, which is highly public, use of personal information is often limited to the minimum extent, for the protection of personal information. The library server 112 of the library 101 in such a case can manage only check-out information as the information related to lending of a book, and the check-out information about the book is deregistered when the book is returned. Therefore, the library server 112 is unable to provide check-out history information that is the user's history of usage of the lending service (the information about the books lent to the user in the past).

To counter this, check-out history information is managed outside the library 101. More specifically, the mobile book-reading account server 113 acquires check-out information from the library server 112, generates and manages check-out history information by using the check-out information, and provides the user 103 (the terminal device 114) with the check-out history information as a mobile book-reading account service.

In this manner, a check-out history information delivery service can be provided, and the convenience of the book lending service can be enhanced. Particularly, as the check-out history information is generated, managed, and delivered outside the library 101 as described above, the check-out history information delivery service can be provided without any change in the specification of the library server 112. Thus, convenience can be enhanced in a service of lending a larger number of books.

The terminal device 114 acquires the check-out history information about the user 103 from the mobile book-reading account server 113, and generates the information to be presented to the user 103. The information to be presented to the user 103 is a check-out history information viewing image that includes the contents of the acquired check-out history information and indicates the lending service usage history of the user 103. The terminal device 114 displays the check-out history information viewing image. The terminal device 114 performs such processing, using an application that has been acquired from the mobile book-reading account server 113 and been installed. Thus, the user 103 can more easily view the check-out history information about himself/herself, without any communication settings or generation of an image for display, for example. That is, the user 103 can more easily recognize the books he/she has borrowed in the past. With this, the user 103 can prevent himself/herself from making a mistake such as borrowing a book he/she has already borrowed in the past. Thus, the convenience of the lending service can be enhanced.

As the check-out history information is generated and managed outside the library 101 in the above manner, an increase in the load on the library server 112 can also be prevented. Thus, the library server 112 can perform other processing by a larger amount and at a higher speed. By virtue of these aspects, the convenience of the lending service can be enhanced.

As the image for viewing is generated in the terminal device 114, an increase in the load on the mobile book-reading account server 113 can also be prevented. Thus, the mobile book-reading account server 113 can perform other processing by a larger amount and at a higher speed. By virtue of these aspects, the convenience of the lending service can be enhanced.

A specific example of the flow of the processing is described below. The check-out information processing unit 173 of the mobile book-reading account server 113 repeatedly requests the check-out information about each user from the library server 112 through the communication unit 134 of the mobile book-reading account server 113 on a regular or irregular basis (step S191), and acquires the check-out information (step S192). It should be noted that the check-out information processing unit 173 may be designed to be able to store this check-out information into the lending information database 182.

Acquiring the request through the communication unit 134 of the library server 112 (step S181), the check-out information management unit 152 of the library server 112 acquires the check-out information about each user from the check-out information database 156, and supplies the acquired check-out information about each user to the mobile book-reading account server 113 as the requester through the communication unit 134 of the library server 112 (step S182).

Every time the check-out information about each user is acquired, the check-out history information processing unit 174 of the mobile book-reading account server 113 incorporates the changes into the check-out history information stored in the lending information database 182 (step S193). When a book is returned, for example, the information about the book is erased from the check-out information, and therefore, the check-out history information processing unit 174 adds the information about the book erased from the check-out information acquired last time, to the check-out history information. It should be noted that the check-out history information may include the information about the currently checked-out books. In that case, the check-out history information processing unit 174 adds the information about a book newly added to the check-out information acquired this time (a newly checked-out book), to the check-out history information.

The check-out information processing unit 173 and the check-out history information processing unit 174 can perform such processing (requesting and acquiring check-out information, and updating (or generating) check-out history information) at appropriate times. Where this processing is performed more often, more up-to-date check-out history information can be maintained. Where this processing is performed less often, on the other hand, the load can be reduced.

As shown in FIG. 9, the check-out history information processing unit 193 of the terminal device 114 receives a check-out history information viewing request through the input unit 131 of the terminal device 114, for example (step S201), and then requests the check-out history information about the user 103 from the mobile book-reading account server 113 through the communication unit 134 of the terminal device 114 (step S202).

Acquiring the request through the communication unit 134 of the mobile book-reading account server 113 (step S194), the check-out history information processing unit 174 of the mobile book-reading account server 113 acquires the requested check-out history information about the user 103 from the lending information database 182, and supplies the acquired check-out history information to the terminal device 114 as the requester through the communication unit 134 of the mobile book-reading account server 113 (step S195).

Acquiring the check-out history information through the communication unit 134 of the terminal device 114 (step S203), the check-out history information processing unit 193 of the terminal device 114 generates a check-out history information viewing image that is an image for displaying the acquired check-out history information (step S204). The check-out history information processing unit 193 of the terminal device 114 then causes the output unit 132 (a display) to display the generated check-out history information viewing image (step S205).

Through this processing, the user 103 can view the check-out history information viewing image displayed on the terminal device 114.

FIG. 10 shows examples of display of check-out history information viewing images. In the example cases shown in FIG. 10, a check-out history information viewing image 202 includes a list of the books the user 103 has borrowed in the past (a check-out history list), information indicating the order in the check-out history list, and the identification information (card ID) about the user 103.

Any appropriate information can be displayed in the check-out history list, as long as the information is related to a book the user 103 has borrowed in the past. For example, in the case shown in A of FIG. 10, only text information related to the books is displayed in the check-out history list. More specifically, the check-out dates of the books, the return dates, the names of the books (titles), and the like are displayed. In this manner, information about more books than in the example shown in B of FIG. 10 can be displayed at once. Information other than the above may of course be included in the check-out history list. For example, the check-out history information may include the names of the authors, the names of the publishers, the dates of publication, the ISBNs, and summaries. As such information is displayed, the user 103 can more easily recognize the books he/she has borrowed in the past. That is, the convenience of the lending service can be enhanced.

In the example case shown in B of FIG. 10, on the other hand, image information 202A such as the front cover of a book is displayed in the check-out history list. Although this image information 202A is represented by a blank square in B of FIG. 10, an image such as the front cover of a book is displayed in this blank square in reality. With this display, the user 103 can more instinctively recognize the books he/she has borrowed in the past. That is, the convenience of the lending service can be enhanced.

Also, in this case, text information about the books, such as the names of the authors, the publishers, the ISBNs, the EANs, and the dates of publication, is more specifically shown in the check-out history list than in A of FIG. 10. Accordingly, the user 103 can more easily recognize the books he/she has borrowed in the past. That is, the convenience of the lending service can be enhanced.

Also, in the cases shown in A of FIG. 10 and B of FIG. 10, “return dates (descending order)” are displayed as the information indicating the order in the check-out history list, and show that the order in the check-out history list is the descending order corresponding to the return dates. With this, the user 103 can more easily recognize the order in the check-out history list.

It should be noted that this display showing the order in the check-out history list may be a GUI that can be operated (tapped, for example) by the user 103 to switch the order to some other kind (or select order). With this, the user 103 can more easily change the order in the check-out history list. Thus, the user 103 can more easily view the information in the check-out history list. That is, the convenience of the lending service can be enhanced.

Also, in a case where an entire check-out history information viewing image cannot be displayed in the display area of the terminal device 114 at once because the number of the books borrowed in the past is large, for example, the check-out history information viewing image may be scrolled for display.

Also, the example shown in A of FIG. 10 and the example shown in B of FIG. 10 may be combined. For example, as for the few books appearing at the top of the check-out history list, more specific information may be displayed as in the example shown in B of FIG. 10. As for the few books appearing at the bottom of the list, less specific information, such as text-only information, may be displayed as in the example shown in A of FIG. 10. Also, the user 103 may be allowed to switch between the example shown in A of FIG. 10 and the example shown in B of FIG. 10 as appropriate. Alternatively, when a book in the check-out history list in the example shown in A of FIG. 10 is selected, more specific information about the selected book may be displayed as in the example shown in B of FIG. 10. In this manner, viewing of the check-out history information becomes easier, and the user 103 can more readily obtain desired information about the books he/she has borrowed in the past.

<Flow of Processing Related to Viewing of Return Notification Information>

Referring now to the flowchart in FIG. 9, the flow of processing related to viewing of return notification information is described. The explanation will also be made with reference to FIG. 11 as necessary.

In the book lending service system 100, when the return due date of a book is approaching (a few days before the due date, for example), a return notification service of prompting the user to check the return due date and return the checked-out book by the return due date is provided so that the user will not forget to return the book.

To provide such a return notification service, the mobile book-reading account server 113 acquires check-out information from the library server 112, and, in accordance with the check-out information, generates return notification information to prompt returning of a currently checked-out book. The mobile book-reading account server 113 then supplies the generated return notification information to the terminal device 114. That is, the mobile book-reading account server 113 may be designed to provide a return notification information delivery service as a mobile book-reading account service.

The terminal device 114 acquires the return notification information from the mobile book-reading account server 113, and generates the information to be presented to the user 103. The information to be presented to the user 103 is a return notification information viewing image that includes the contents of the acquired return notification information and prompts returning of the checked-out book. The terminal device 114 displays the return notification information viewing image. The terminal device 114 performs such processing, using an application that has been acquired from the mobile book-reading account server 113 and been installed.

This application can stay in a running state (or in such a state as to be able to perform at least the processing related to reception) in the terminal device 114. Accordingly, the terminal device 114 can receive return notification information transmitted from the mobile book-reading account server 113, generate a return notification information viewing image, and display the return notification information viewing image (displaying a so-called pop-up window) at any appropriate time, without the need for an instruction or the like from the user 103. Thus, the terminal device 114 can display an image for viewing the return notification information transmitted from the mobile book-reading account server 113 in an instantaneous manner (with a shorter time lag from the transmission).

That is, the mobile book-reading account server 113 can send this return notification in the form of a so-called push notification, and accordingly, send the return notification to the user 103 at a more appropriate time. With this, the user 103 can be more reliably prevented from forgetting to return a book. Thus, delays in returning books can be reduced, and the convenience of the book lending service can be enhanced.

As the return notification information is generated outside the library 101 (or in the mobile book-reading account server 113) and is then transmitted in the above manner, an increase in the load on the library server 112 can also be prevented. Thus, the library server 112 can perform other processing by a larger amount and at a higher speed. By virtue of these aspects, the convenience of the lending service can be enhanced.

As the image for viewing is generated in the terminal device 114, an increase in the load on the mobile book-reading account server 113 can also be prevented. Thus, the mobile book-reading account server 113 can perform other processing by a larger amount and at a higher speed. By virtue of these aspects, the convenience of the lending service can be enhanced.

A specific example of the flow of the processing is described below. The return notification processing unit 175 of the mobile book-reading account server 113 repeatedly checks the return due date(s) in the check-out information about each user stored in the lending information database 182 on a regular or irregular basis (step S196). It should be noted that, in a case where any check-out information is not stored in the lending information database 182, the return notification processing unit 175 carries out procedures similar to those in steps S191 and S192, to acquire the check-out information about each user from the library server 112.

In a case where there exists check-out information that satisfies a predetermined condition for return due dates, or where there exists check-out information that has a fewer days before the return due date than a predetermined number of days, the return notification processing unit 175 generates return notification information about the check-out information (step S197), and supplies the generated return notification information to the terminal device 114 of the user (the user 103, for example) as the notification destination of the return notification information through the communication unit 134 of the mobile book-reading account server 113 (step S198).

Acquiring the return notification information through the communication unit 134 of the terminal device 114 (step S206), the return notification processing unit 194 of the terminal device 114 generates a return notification information viewing image that is an image for displaying the acquired return notification information (step S207). The return notification processing unit 194 of the terminal device 114 then causes the output unit 132 (a display) to display the generated return notification information viewing image (step S208).

Through this processing, the user 103 can view the return notification information viewing image displayed on the terminal device 114.

FIG. 11 shows an example of display of a return notification information viewing image. In the example case shown in FIG. 11, a return notification information viewing image 203 shows information related to the lending of the book to be returned (the name of the book, the name of the author, the check-out date, and the return due date, for example), as well as the message “Notice of Return Due Date” indicating that the information is a return notification and the message “Please return the above book without fail by the return due date” prompting the return.

With such a return notification, the user 103 can more easily recognize the existence of a book to be returned. Also, the user 103 can more easily recognize which book he/she should return among the currently borrowed books. Furthermore, this return notification information viewing image is displayed in a pop-up window without any instruction from the user, and accordingly, the user 103 can more promptly recognize the contents of this return notification. That is, the convenience of the lending service can be enhanced.

The information that is related to the lending of a book to be returned and is shown in this return notification information viewing image 203 is not limited to the example shown in FIG. 11, and may of course include any appropriate information. For example, the information may include more specific information about the book, such as the names of the publisher, the date of publication, the ISBN, and a summary. The information may also include an image of the front cover or the like of the book. With such display, the user 103 can more accurately recognize the book he/she should return.

It should be noted that, when the user 103 operates the return notification information viewing image 203 displayed on the terminal device 114 (or taps the screen, for example), the check-out information related to the book that is the subject of the return notification may be displayed. For example, the check-out information viewing image 201 described above with reference to FIG. 8 may be displayed.

It should be noted that the time to send the return notification (or the condition to be satisfied) may be determined as appropriate, and is not necessarily determined by the number of days before the return due date. For example, the time to send the return notification may fall on the return due date, or may be after the return due date. Also, the time to send the return notification may be a predetermined days after the check-out date. Alternatively, the time to send the return notification may fall on a predetermined date or a predetermined day of week. Also, the time to send the return notification may fall on a day on which the user 103 often visit the library 101 or one day before such a day, or may be when another user makes a reservation. Further, the time to send the return notification may be when multiple conditions are satisfied. The condition may also be changed for each user. In the case of a user who has failed to meet a return due date many times in the past, the return notification may be sent in an earlier stage. Also, the return notification may be sent multiple times before the return due date (or until the book is returned). Further, every time a notification is sent, the contents (such as the message, the colors, the design, and the layout) of the return notification may be changed.

<Flow of Processing Related to Viewing of Recommendation Notification Information>

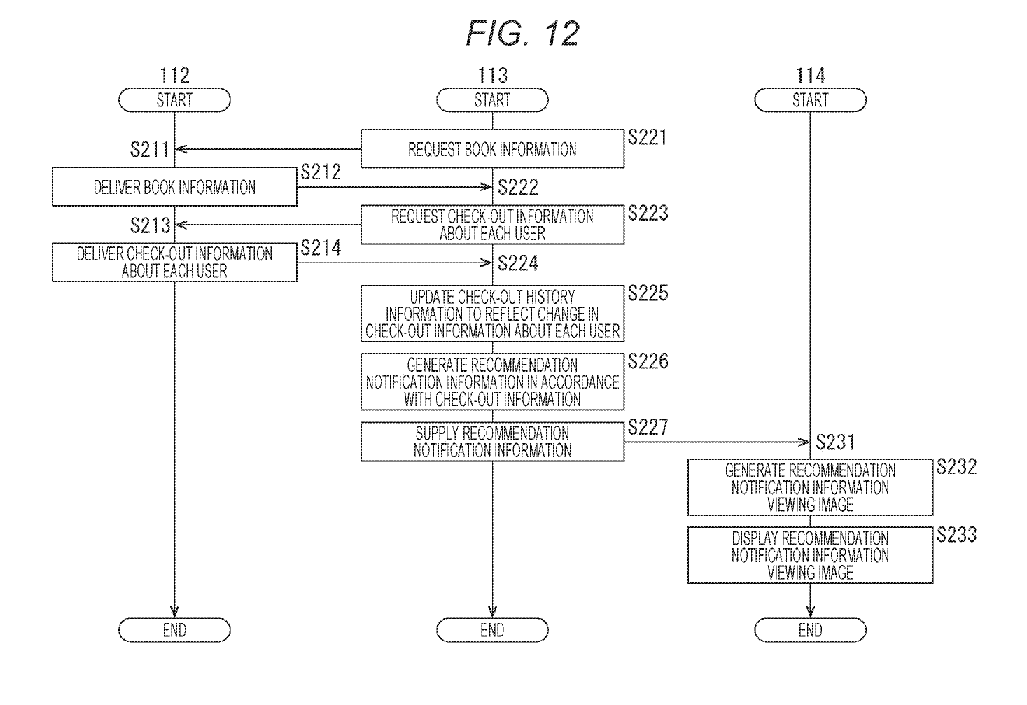

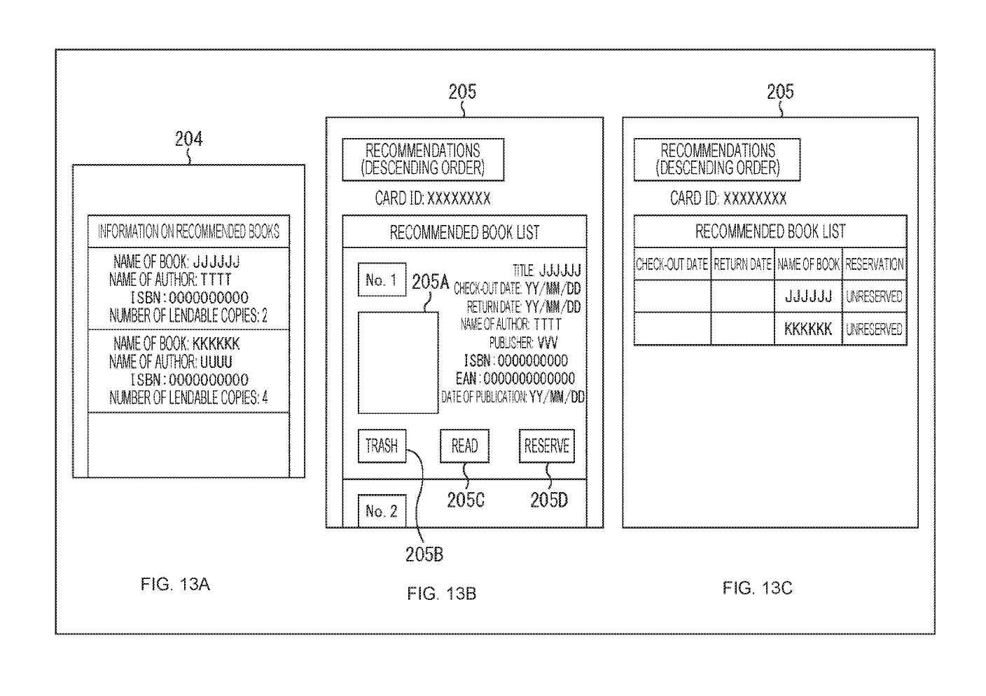

Referring now to the flowchart in FIG. 12, the flow of processing related to viewing of recommendation notification information is described. The explanation will also be made with reference to FIG. 13 as necessary.

In the book lending service system 100, a recommendation notification service of recommending books to a user is provided to prompt usage of the book lending service, for example.

In this recommendation notification service, books to be recommended (recommended books) are selected from among the books that are the objects in the lending service, for example. Also, the recommended books are selected in accordance with the check-out history of the user. That is, the recommended books are selected in accordance with the book information about the books that are the objects in the lending service, and with the lending information (the check-out information and the check-out history information) about the user. As described above, the check-out history information is managed in the mobile book-reading account server 113 outside the library 101. Therefore, the processing related to a recommended book notification including selection of recommended books is performed in the mobile book-reading account server 113 outside the library 101.

That is, to provide such a recommendation notification service, the mobile book-reading account server 113 generates recommendation notification information for recommending books to a user, in accordance with the book information and the check-out information acquired from the library server 112, and with the check-out history information updated in accordance with the check-out information. The mobile book-reading account server 113 then supplies the generated recommendation notification information to the terminal device 114. That is, the mobile book-reading account server 113 may be designed to provide a recommendation notification information delivery service as a mobile book-reading account service.

As the processing related to a recommendation notification is performed in the mobile book-reading account server 113 outside the library 101 in the above manner, an increase in the load on the library server 112 can also be prevented. Thus, the library server 112 can perform other processing by a larger amount and at a higher speed. By virtue of these aspects, the convenience of the lending service can be enhanced.

Also, with the above processing, the recommendation notification service can be provided, without any change in the specification of the library server 112. Thus, convenience can be enhanced in a service of lending a larger number of books.

The terminal device 114 acquires the recommendation notification information from the mobile book-reading account server 113, and generates the information to be presented to the user 103. The information to be presented to the user 103 is a recommendation notification information viewing image that includes the contents of the acquired recommendation notification information and indicates the recommended books to the user. The terminal device 114 displays the recommendation notification information viewing image. The terminal device 114 performs such processing, using an application that has been acquired from the mobile book-reading account server 113 and been installed.

This application can stay in a running state (or in such a state as to be able to perform at least the processing related to reception) in the terminal device 114. Accordingly, the terminal device 114 can receive recommendation notification information transmitted from the mobile book-reading account server 113, generate a recommendation notification information viewing image, and display the recommendation notification information viewing image in a pop-up window at any appropriate time, without the need for an instruction or the like from the user 103. Thus, the terminal device 114 can display an image for viewing the recommendation notification information transmitted from the mobile book-reading account server 113 in an instantaneous manner (with a shorter time lag from the transmission).

That is, the mobile book-reading account server 113 can send this recommendation notification in the form of a so-called push notification, and accordingly, send the recommendation notification to the user 103 at a more appropriate time. For example, the mobile book-reading account server 113 can transmit this recommendation notification to the terminal device 114 when the user 103 enters the library 101. In general, the user 103 entering the library 101 can be regarded as being highly motivated to use the book lending service. Therefore, the recommended books are presented to the user 103 at the specific time, to increase the likelihood of the user 103 referring to the recommendation notification with strong interest. Thus, sending the “recommendation notification” easily leads to “usage of the lending service”. That is, the recommending effect can be enhanced.

In the above manner, the mobile book-reading account server 113 can present the recommendation notification to the user at a more suitable time (or make recommendations in a timely fashion). Thus, the mobile book-reading account server 113 can increase the recommending effect, and enhance the convenience of the book lending service.

As the image for viewing is generated in the terminal device 114, an increase in the load on the mobile book-reading account server 113 can also be prevented. Thus, the mobile book-reading account server 113 can perform other processing by a larger amount and at a higher speed. By virtue of these aspects, the convenience of the lending service can be enhanced.

A specific example of the flow of the processing is described below. The recommendation notification processing unit 176 of the mobile book-reading account server 113 requests and acquires book information from the library server 112 through the communication unit 134 of the mobile book-reading account server 113 (step S221 and step S222). For example, the recommendation notification processing unit 176 requests and acquires the book information about all the books that are the objects in the lending service of the library 101. The recommendation notification processing unit 176 stores the acquired book information into the book information database 183, and manages the book information therein.

Meanwhile, acquiring the request through the communication unit 134 of the library server 112 (step S211), the book information management unit 153 of the library server 112 acquires the requested book information from the book information database 157, and supplies the book information to the mobile book-reading account server 113 through the communication unit 134 of the library server 112 (step S212).

The recommendation notification processing unit 176 of the mobile book-reading account server 113 and the book information management unit 153 of the library server 112 repeatedly perform such processing on a regular or irregular basis. With this, more up-to-date book information can be maintained in the book information database 183.

Also, the recommendation notification processing unit 176 of the mobile book-reading account server 113 acquires the check-out information about each user from the library server 112, stores and manages the check-out information, and updates the check-out history information about each user as necessary (steps S223 through S225), as in steps S191 through S193 in FIG. 9.

Meanwhile, the check-out information management unit 152 of the library server 112 reads the check-out information about each user from the check-out information database 156, and supplies the check-out information to the mobile book-reading account server 113 (step S213 and step S214), as in steps S181 and S182 in FIG. 9.

The recommendation notification processing unit 176 of the mobile book-reading account server 113 and the check-out information management unit 152 of the library server 112 repeatedly perform such processing on a regular or irregular basis. With this, more up-to-date check-out information and check-out history information can be maintained in the lending information database 182.

The recommendation notification processing unit 176 generates recommendation notification information about the lending information and the book information (step S226), and supplies the generated recommendation notification information to the terminal device 114 of the user (the user 103, for example) as the notification destination through the communication unit 134 of the mobile book-reading account server 113 (step S227).

Acquiring the recommendation notification information through the communication unit 134 of the terminal device 114 (step S231), the recommendation notification processing unit 195 of the terminal device 114 generates a recommendation notification information viewing image that is an image for displaying the acquired recommendation notification information (step S232). The recommendation notification processing unit 195 of the terminal device 114 then causes the output unit 132 (a display) to display the generated recommendation notification information viewing image (step S233).

Through this processing, the user 103 can view the recommendation notification information viewing image displayed on the terminal device 114.

FIG. 13 shows examples of display of a recommendation notification information viewing image. For example, a recommendation notification information viewing image 204 shown in A of FIG. 13 is first displayed in a pop-up window. This recommendation notification information viewing image 204 shows the message “Information on Recommended Books” indicating that the information is about recommended books, and also shows a list of the recommended books. The list of the recommended books shows the information about each recommended book. For example, the list of the recommended books shows the names of the books, the names of the authors, the ISBNs, the numbers of lendable copies (information indicating the lending statuses of the recommended books), and the like. The information is set as appropriate, and information other than the above may of course be included in the list of the recommended books.

Also, when the user 103 operates the recommendation notification information viewing image 204 displayed in a pop-up window (or taps the screen, for example), a recommendation notification information viewing image 205 having the layout shown in B of FIG. 13 may be displayed, for example.

In the example case shown in B of FIG. 13, the recommendation notification information viewing image 205 includes a list of the recommended books (a recommended book list), information indicating the order in the recommended book list, and the identification information (card ID) about the user 103.

The recommended book list shows image information 205A such as the front cover of a recommended book. Although this image information 205A is represented by a blank square in B of FIG. 13, an image such as the front cover of the book is displayed in this blank square in reality. With this display, the user 103 can more instinctively recognize the recommended books. That is, the convenience of the lending service can be enhanced.

The recommended book list also shows text information about the recommended books, such as the titles, the check-out dates, the return dates, the names of the authors, the publishers, the ISBNs, the EANs, and the dates of publication. Accordingly, the user 103 can more easily recognize the recommended books. That is, the convenience of the lending service can be enhanced.

The recommendation notification information viewing image 205 in the example shown in B of FIG. 13 further shows a trash box GUI button 205B for the user 103 to operate (or tap the corresponding portion on the screen) to delete the recommendation notification on the book (or to make the book not to be recommended). By operating this trash box GUI button 205B, the user 103 can delete the information about the books that do not need to be recommended from the recommendation notification information viewing image 205, so that the recommendation notification information viewing image 205 can be made easier to view.

The recommendation notification information viewing image 205 in the example shown in B of FIG. 13 also shows a read GUI button 205C for the user 103 to operate (or tap the corresponding portion on the screen) to indicate that the user 103 has already read the recommended book. By operating this read GUI button 205C, the user 103 can more easily identify the recommended book(s) he/she has already read in the recommendation notification information viewing image 205.

The recommendation notification information viewing image 205 in the example shown in B of FIG. 13 further shows a reservation GUI button 205D for the user 103 to operate (or tap the corresponding portion on the screen) to reserve the recommended book to be lent out. By operating this reservation GUI button 205D, the user 103 can more easily reserve a recommended book to be lent out. That is, the recommending effect can be increased, and the convenience of the lending service can be increased.

Any appropriate GUI button other than the above may of course be formed in the recommendation notification information viewing image 205. For example, it is possible to form a purchase GUI button that is a GUI for the user 103 to operate to purchase a recommended book.

Also, in the case shown in B of FIG. 13, “recommendations (descending order)” are displayed as the information indicating the order in the recommended book list, and show that the order in the recommended book list is the descending order corresponding to the degrees of recommendation. With this, the user 103 can more easily recognize the order in the recommended book list.

It should be noted that this display showing the order in the recommended book list may be a GUI that can be operated (tapped, for example) by the user 103 to switch the order to some other kind (or select order). With this, the user 103 can more easily change the order in the recommended book list. Thus, the user 103 can more easily view the information in the recommended book list. That is, the convenience of the lending service can be enhanced.

It should be noted that the recommendation notification information viewing image 205 may also be formed only with text information as in the example shown in C of FIG. 13. In the example case shown in C of FIG. 13, images such as the front covers or the like of the books are not shown in the recommended book list, and the recommended book list is formed as a text information list. This list shows information such as the check-out dates, the return dates, the names of the books, and the reservation statuses. In this manner, information about a larger number of books can be displayed at once.

Also, in a case where the entire recommendation notification information viewing image 205 cannot be displayed in the display area of the terminal device 114 at once because the number of the recommended books is large, for example, the recommendation notification information viewing image 205 may be scrolled for display.

Also, the example shown in B of FIG. 13 and the example shown in C of FIG. 13 may be combined. For example, as for the few recommended books appearing at the top of the recommended book list, more specific information may be displayed as in the example shown in B of FIG. 13. As for the few recommended books appearing at the bottom of the list, less specific information, such as text-only information, may be displayed as in the example shown in C of FIG. 13. Also, the user 103 may be allowed to switch between the example shown in B of FIG. 13 and the example shown in C of FIG. 13 as appropriate. Alternatively, when a recommended book in the recommended book list in the example shown in C of FIG. 13 is selected, more specific information about the selected book may be displayed as in the example shown in B of FIG. 13. In this manner, viewing of the recommendation notification information becomes easier, and the user 103 can more readily obtain desired information about the recommended books.

The above described selection of a recommended book can be performed by any appropriate method. For example, the recommendation notification processing unit 176 may select a recommended book only in accordance with the book information and the lending information (the check-out information and the check-out history information) about the user 103 as the destination of the recommendation notification. In this manner, recommendations that match the preferences of the user 103 with higher precision can be made. The recommendation notification processing unit 176 may also select a recommended book in accordance with the book information and the lending information (the check-out information and the check-out history information) about multiple users (all the users, for example). In this manner, recommendations that reflect the trend of the times can be made (for example, popular books and topical books are recommended).

A recommended book may of course be selected in accordance with information other than the book information and the lending information. For example, a recommended book may be selected in accordance with lending statuses. For example, all the copies of a book are checked out, and therefore, the book cannot be lent out (the book having a waiting list). Such a book is not recommended.

Alternatively, a recommended book may be selected by a combination of multiple methods.

<Flow of Processing Related to Book Purchasing>

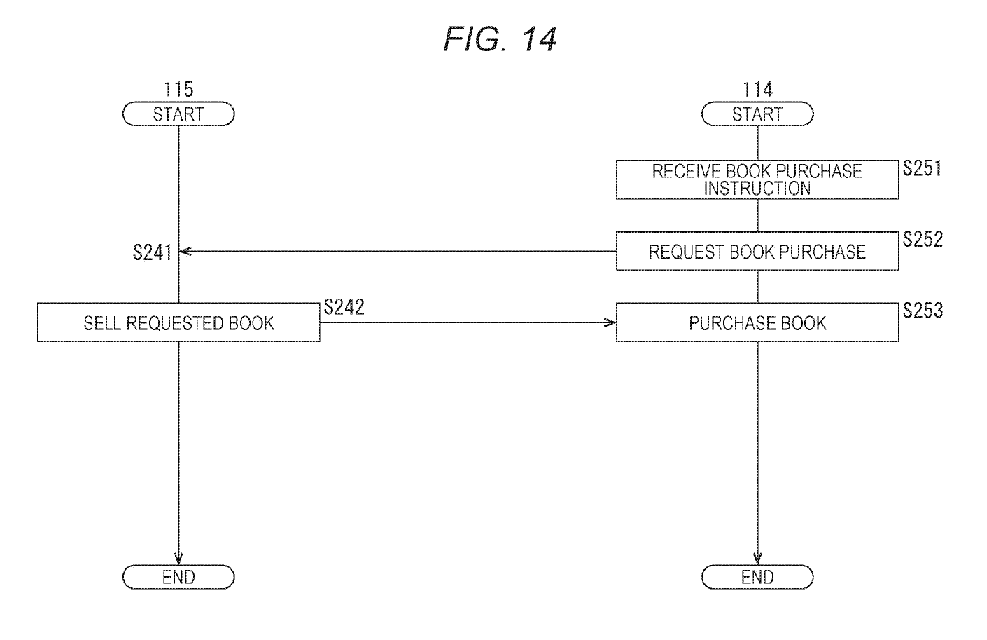

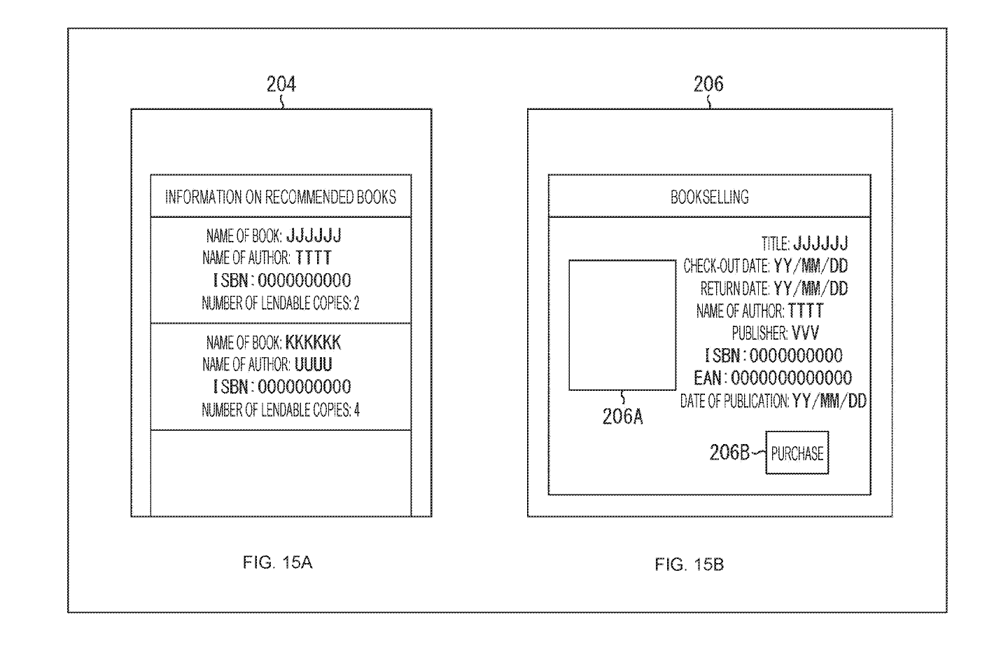

Referring now to the flowchart in FIG. 14, the flow of processing related to book purchasing is described. The explanation will also be made with reference to FIG. 15 as necessary.

In the book lending service system 100, a bookselling service is provided so that a book (a published book) recommended in a recommendation notification information viewing image can be purchased, for example. This bookselling service is provided by the bookselling server 115 (of the bookseller 104) outside the library 101.

To provide such a bookselling service, the bookselling server 115 performs processing related to bookselling in response to a request from the terminal device 114.

As the processing related to bookselling is performed in the bookselling server 115 outside the library 101 in the above manner, an increase in the load on the library server 112 can be prevented. Thus, the library server 112 can perform other processing by a larger amount and at a higher speed. By virtue of these aspects, the convenience of the lending service can be enhanced.

Also, with the above processing, the bookselling service can be provided, without any change in the specification of the library server 112. Thus, convenience can be enhanced in a service of lending a larger number of books.

In accordance with an instruction or the like from the user 103, the terminal device 114 requests the bookselling server 115 to sell a desired book, and performs processing related to the purchasing. The terminal device 114 performs such processing, using an application that has been acquired from the mobile book-reading account server 113 and been installed. Accordingly, the processing related to the book purchasing can be performed, without any increase in the load on the library server 112 and any change in the specification of the library server 112. Thus, the convenience of the lending service can be enhanced.

A specific example of the flow of the processing is described below. In step S251, the book purchase processing unit 196 of the terminal device 114 receives a book purchase instruction through the input unit 131 of the terminal device 114. For example, the user 103 selects a desired book (a published book) from among the recommended books included in the recommendation notification information viewing image displayed on the output unit 132 of the terminal device 114, and inputs the purchase instruction through the input unit 131. The book purchase processing unit 196 receives the purchase instruction.

After receiving the instruction, the book purchase processing unit 196 requests the desired book purchase from the bookselling server 115 through the communication unit 134 of the terminal device 114 in step S252.

After receiving the request in step S241, the bookselling processing unit 161 of the bookselling server 115 exchanges the information necessary for the bookselling with the terminal device 114 via the communication unit 134 of the bookselling server 115, and performs processing to sell the requested book in step S242. For example, using the information that is related to the book requested by the terminal device 114 and is stored in the book database 162, the bookselling processing unit 161 performs processing related to bookselling, such as payment collection and book delivery procedures. Also, in the case of selling the electronic data of the book, for example, the bookselling processing unit 161 transmits the electronic data that is of the book requested by the terminal device 114 and is stored in the book database 162, and collects the payment and the like.

In step S253, the book purchase processing unit 196 exchanges the information necessary for the book purchasing with the bookselling server 115 via the communication unit 134 of the terminal device 114, and performs processing to purchase the book requested by the user. For example, the book purchase processing unit 196 performs processing related to the payment for the purchased book. In the case of purchasing the electronic data of the book, for example, the book purchase processing unit 196 receives the electronic data of the requested book.

As shown in A of FIG. 15, for example, a recommendation notification information viewing image 204 is displayed on the output unit 132 (a display) of the terminal device 114. When the user 103 selects one of the books (published books), the user 103 is guided to a site being managed by the bookselling server 115. For example, a bookselling image 206 having the layout shown in B of FIG. 15 is displayed on the output unit 132 (a display) of the terminal device 114. This bookselling image 206 shows an image 206A of the front cover or the like of the book to be sold (the book designated by the terminal device 114), the information about the book, a purchase GUI button 206B for the user 103 to operate (or tap the corresponding portion on the screen, for example) to perform the processing related to the purchasing of the book, and the like.

By operating this purchase GUI button 206B, the user 103 can more easily purchase a recommended book. That is, the recommending effect can be increased, and the convenience of the lending service can be increased.

It should be noted that the user 103 (the terminal device 114) may be allowed to purchase a book from any appropriate image other than a recommendation notification information viewing image. For example, the user 103 may be allowed to select and purchase a book from check-out information, check-out history information, or the like.

<Flow of Processing Related to Book Lending Reservation>

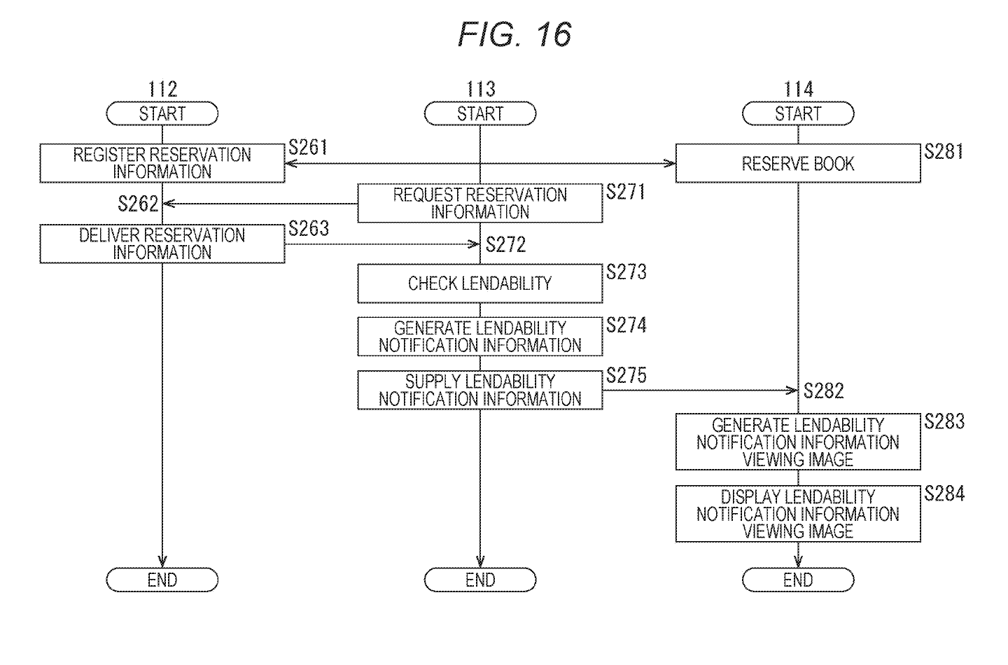

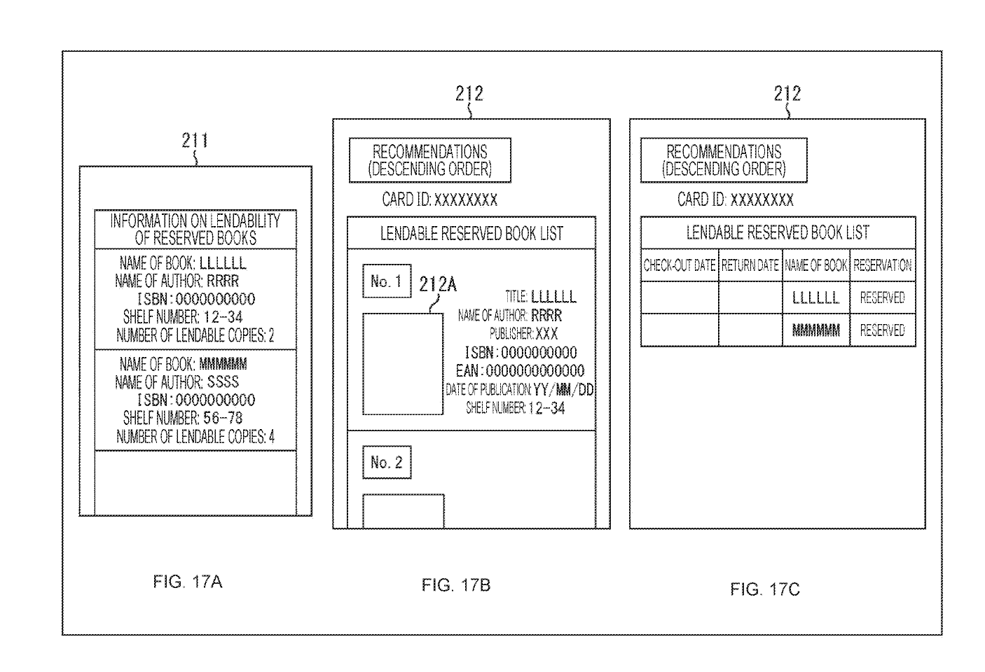

Referring now to the flowchart in FIG. 16, the flow of processing related to book lending reservation is described. The explanation will also be made with reference to FIG. 17 as necessary.

Also, in the book lending service system 100, a book lending reservation can be made. The reservation information is managed at the library 101 (the library server 112) In regard to this reservation, when the reserved book is returned and becomes lendable, a lendability notification is issued to notify the user 103, who has reserved the book, that the book is now lendable (a lendability notification service is provided). Such a lendability notification service is provided by the mobile book-reading account server 113 (of the mobile book-reading account service provider 102) outside the library 101. That is, the mobile book-reading account server 113 may be designed to provide a lendability notification information delivery service as a mobile book-reading account service.

To provide such a lendability notification service, the mobile book-reading account server 113 acquires reservation information from the library server 112, and, in accordance with the reservation information, generates the lendability notification information indicating that the book reserved by the user can be lent out. The mobile book-reading account server 113 then supplies the generated lendability notification information to the terminal device 114.

As the processing related to a lendability notification is performed in the mobile book-reading account server 113 outside the library 101 in the above manner, an increase in the load on the library server 112 can be prevented. Thus, the library server 112 can perform other processing by a larger amount and at a higher speed. By virtue of these aspects, the convenience of the lending service can be enhanced.

Also, with the above processing, the lendability notification service can be provided, without any change in the specification of the library server 112. Thus, convenience can be enhanced in a service of lending a larger number of books.

The terminal device 114 acquires the lendability notification information from the mobile book-reading account server 113, and generates the information to be presented to the user 103. The information to be presented to the user 103 is a lendability notification information viewing image that includes the contents of the acquired lendability notification information and indicates that the book reserved by the user can be lent out. The terminal device 114 displays the lendability notification information viewing image. The terminal device 114 performs such processing, using an application that has been acquired from the mobile book-reading account server 113 and been installed.

This application can stay in a running state (or in such a state as to be able to perform at least the processing related to reception) in the terminal device 114. Accordingly, the terminal device 114 can receive lendability notification information transmitted from the mobile book-reading account server 113, generate a lendability notification information viewing image, and display the lendability notification information viewing image in a pop-up window at any appropriate time, without the need for an instruction or the like from the user 103. Thus, the terminal device 114 can display an image for viewing the lendability notification information transmitted from the mobile book-reading account server 113 in an instantaneous manner (with a shorter time lag from the transmission).

That is, the mobile book-reading account server 113 can send this lendability notification in the form of a so-called push notification, and accordingly, instantaneously notify the user 103 that the reserved book is now lendable. Accordingly, the user 103 can borrow the reserved book after a shorter period of time. In other words, the period from the return of the book till the next check-out can be shortened, and accordingly, service usage efficiency can be increased in the lending service. That is, the convenience of the book lending service can be enhanced.

As the image for viewing is generated in the terminal device 114, an increase in the load on the mobile book-reading account server 113 can also be prevented. Thus, the mobile book-reading account server 113 can perform other processing by a larger amount and at a higher speed. By virtue of these aspects, the convenience of the lending service can be enhanced.

A specific example of the flow of the processing is described below. First, the user 103 (the terminal device 114) reserves a desired book to be lent out. In step S281, the reservation processing unit 197 of the terminal device 114 communicates with the library server 112 via the communication unit 134 of the terminal device 114, and reserves the desired book to be lent out. Meanwhile, in step S261, the reservation information management unit 154 of the library server 112 receives the reservation request from the terminal device 114 through the communication unit 134 of the library server 112, generates reservation information that is the information about the reservation, and registers the reservation information into the reservation information database 158.

This reservation information includes the information about the reserved book (such as the name of the book and the name of the author), the name of the user who has made the reservation (such as the card ID), and the information related to the lending status of the reserved book (such as the lendability and the expected return date (or the date on which the book becomes lendable)), for example. The contents of the reservation information are determined as appropriate, and may of course include information other than the above. For example, in a case where multiple users reserve the same book, the reservation information may include information indicating the reservation order (check-out priority order) among the users.

The mobile book-reading account server 113 also repeatedly acquires the reservation information from the library server 112 on a regular or irregular basis, and manages the reservation information. The reservation notification processing unit 177 of the mobile book-reading account server 113 communicates with the library server 112 via the communication unit 134 of the mobile book-reading account server 113, to request and acquire the reservation information registered in the reservation information database 158 (step S271 and step S272). The reservation notification processing unit 177 then registers the acquired reservation information into the reservation information database 184.

Meanwhile, receiving the request from the mobile book-reading account server 113 through the communication unit 134 of the library server 112, the reservation information management unit 154 of the library server 112 reads the reservation information from the reservation information database 158 in accordance with the request, and supplies the reservation information to the mobile book-reading account server 113 through the communication unit 134 of the library server 112 (step S262 and step S263).

The reservation notification processing unit 177 of the mobile book-reading account server 113 and the reservation information management unit 154 of the library server 112 repeatedly perform such processing on a regular or irregular basis. With this, more up-to-date reservation information can be maintained in the reservation information database 184.

In step S273, the reservation notification processing unit 177 checks the reservation information in the reservation information database 184, and determines whether the reserved book is now lendable. The reservation notification processing unit 177 repeats this checking on a regular or irregular basis.

When the reserved book becomes lendable, the reservation notification processing unit 177 generates lendability notification information about the book (step S274), and supplies the generated lendability notification information to the terminal device 114 of the user (the user 103, for example) as the notification destination through the communication unit 134 of the mobile book-reading account server 113 (step S275).

Acquiring the lendability notification information through the communication unit 134 of the terminal device 114 (step S282), the reservation processing unit 197 of the terminal device 114 generates a lendability notification information viewing image that is an image for displaying the acquired lendability notification information (step S283). The reservation processing unit 197 of the terminal device 114 then causes the output unit 132 (a display) to display the generated lendability notification information viewing image (step S284).

Through this processing, the user 103 can view the lendability notification information viewing image displayed on the terminal device 114.

FIG. 17 shows examples of display of a lendability notification information viewing image. For example, a lendability notification information viewing image 211 shown in A of FIG. 17 is first displayed in a pop-up window. This lendability notification information viewing image 211 shows the message “Information on Lendability of Reserved Books” indicating that the information is about reserved books, and also shows a list of the reserved books that are now lendable. The list of the now lendable books shows the information about each book. For example, the list shows the names of the books, the names of the authors, the ISBNs, the shelf numbers as the identification information about the shelves on which the books are kept (or the information indicating the locations of the books), the numbers of lendable copies as the information indicating the lending statuses of the books, and the like. This information is set as appropriate, and information other than the above may of course be included in the list of the now lendable books.

Also, when the user 103 operates the lendability notification information viewing image 211 displayed in a pop-up window (or taps the screen, for example), a lendability notification information viewing image 212 having the layout shown in B of FIG. 17 may be displayed, for example.

In the example case shown in B of FIG. 17, the lendability notification information viewing image 212 includes a list of the lendable books (a lendable reserved book list), information indicating the order in the lendable reserved book list, and the identification information (card ID) about the user 103.

The lendable reserved book list shows image information 212A such as the front cover of a book that is now lendable. Although this image information 212A is represented by a blank square in B of FIG. 17, an image such as the front cover of the book is displayed in this blank square in reality. With this display, the user 103 can more instinctively recognize the lendable books, and more readily borrow any of the books. That is, the convenience of the lending service can be enhanced.

The lendable reserved book list also shows text information about the currently lendable books, such as the titles, the names of the authors, the publishers, the ISBNs, the EANs, the dates of publication, and the shelf numbers. Accordingly, the user 103 can more easily recognize the books that are now lendable. That is, the convenience of the lending service can be enhanced. The lendable reserved book list may of course show information other than the above, such as the numbers of lendable copies.

Also, in the case shown in B of FIG. 17, “recommendations (descending order)” are displayed as the information indicating the order in the lendable reserved book list, and show that the order in the lendable reserved book list is the descending order corresponding to the degrees of recommendation. With this, the user 103 can more easily recognize the order in the lendable reserved book list.

It should be noted that this display showing the order in the lendable reserved book list may be a GUI that can be operated (tapped, for example) by the user 103 to switch the order to some other kind (or select order). With this, the user 103 can more easily change the order in the lendable reserved book list. Thus, the user 103 can more easily view the information in the lendable reserved book list. That is, the convenience of the lending service can be enhanced.

It should be noted that the lendability notification information viewing image 212 may also be formed only with text information as in the example shown in C of FIG. 17. In the example case shown in C of FIG. 17, images such as the front covers or the like of the books are not shown in the lendable reserved book list, and the lendable reserved book list is formed as a text information list. This list shows information such as the check-out dates, the return dates, the names of the books, and the reservation statuses. In this manner, information about a larger number of books can be displayed at once. Information other than the above may of course be displayed in this list.

Also, in a case where the entire lendability notification information viewing image 211 or the entire lendability notification information viewing image 212 cannot be displayed in the display area of the terminal device 114 at once because the number of the now lendable books is large, for example, the lendability notification information viewing image 211 or the lendability notification information viewing image 212 may be scrolled for display.

Also, the example shown in B of FIG. 17 and the example shown in C of FIG. 17 may be combined. For example, as for the few books appearing at the top of the lendable book list, more specific information may be displayed as in the example shown in B of FIG. 17. As for the few books appearing at the bottom of the list, less specific information, such as text-only information, may be displayed as in the example shown in C of FIG. 17. Also, the user 103 may be allowed to switch between the example shown in B of FIG. 17 and the example shown in C of FIG. 17 as appropriate. Alternatively, when a book in the lendable reserved book list in the example shown in C of FIG. 17 is selected, more specific information about the selected book may be displayed as in the example shown in B of FIG. 17. In this manner, viewing of the lendability notification information viewing image 212 becomes easier, and the user 103 can more readily obtain desired information about the lendable books.

In the above manner, the book lending service system 100 can provide various services based on information related to lending. Thus, the convenience of the lending service can be enhanced.

It should be noted that the book lending service system 100 may provide at least one of the various services described above, or may skip one of the services. The book lending service system 100 may also provide services other than the above described services.

### 2. Second Embodiment

<Book Lending Service System>

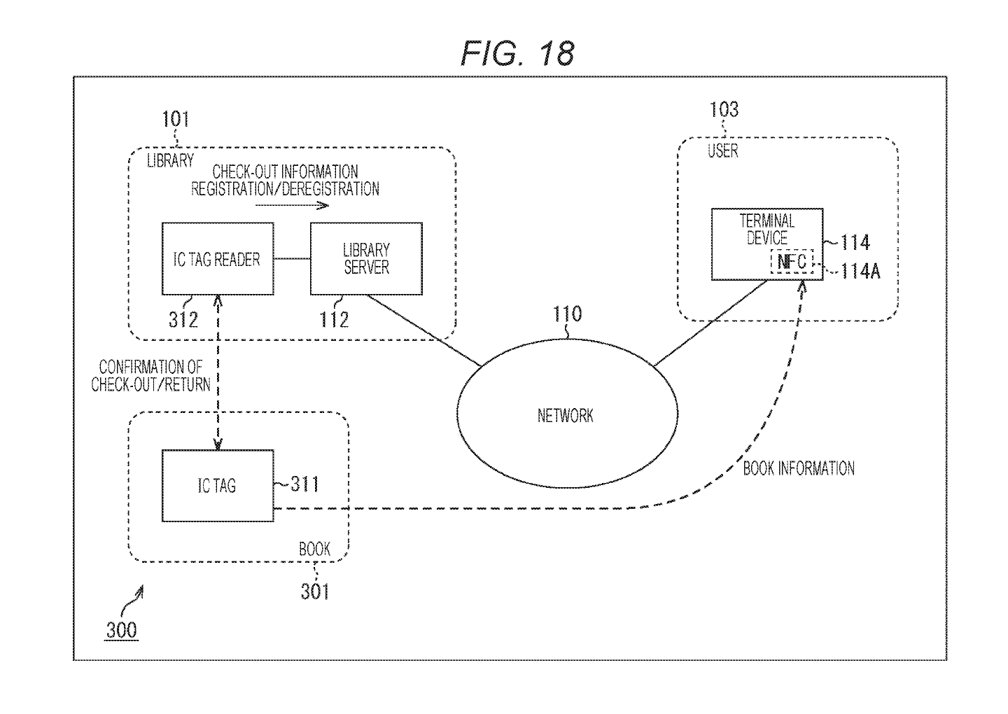

It should be noted that the services of providing aid in a book lending service based on information related to lending are not limited to the various services described above in the first embodiment. For example, an IC tag may be attached to each book, and the IC tag and an IC tag reader may be used in managing lending and returning of the books. FIG. 18 is a diagram for explaining the outline of a book lending service system that is an embodiment of an information processing system to which the present technology is applied.

Like the book lending service system 100, the book lending service system 300 shown in FIG. 18 is a system that provides aid in a lending service to be provided by a library 101 to lend out books (published books). However, the book lending service system 300 provides aid in lending and returning of books, using IC tags and an IC tag reader.

An IC tag 311 is attached (bonded, for example) to each book 301 that is an object in the lending service of the library 101. The IC tag 311 stores information about the book (book information).

As shown in FIG. 1, the library 101 has a library server 112 and an IC tag reader 312. The IC tag reader 312 is compatible with the IC tag 311 attached to each book, and is capable of reading information (book information, for example) stored in an IC tag 311 at an appropriate location in the vicinity. The IC tag reader 312 then supplies the book information read from the IC tag 311 to the library server 112, and causes the library server 112 to generate or deregister the check-out information about the book.

The IC tag reader 312 can be installed at any appropriate location, and may be installed on a bookshelf on which the books are kept (the books are on display), for example. In this case, the IC tag reader 312 detects an IC tag located in the vicinity, and senses that the corresponding book is put (kept) on the bookshelf. Also, when an IC tag cannot be detected, the IC tag reader 312 senses that the corresponding book has been moved (removed) from the bookshelf.

Meanwhile, the terminal device 114 of a user 103 in this case has a Near Field Communication (NFC) 114A as a communication function of the communication unit 134. Using the functions of this NFC 114A, the terminal device 114 can perform non-contact communication (near field communication) with an NFC device located in the vicinity. This NFC 114A also performs wireless communication in a frequency band that is the same as or similar to that of each IC tag 311. That is, using the functions of this NFC 114A, the terminal device 114 can perform wireless communication with an IC tag 311 located in the vicinity. In other words, the terminal device 114 can read, from an IC tag 311 located in the vicinity, the book information or the like about the book having the IC tag 311 attached thereto (or can function as an IC tag reader).

It should be noted that, although the library 101, the user 103, and the book 301 are shown as single components in FIG. 18, the numbers of these components may be determined as appropriate, and may be two or greater.

Also, in FIG. 18, the IC tag reader 312, the library server 112, the IC tag 311, and the terminal device 114 are shown as single components However, the numbers of these components may be determined as appropriate, and may be two or greater.

<Physical Configuration of an IC Tag>

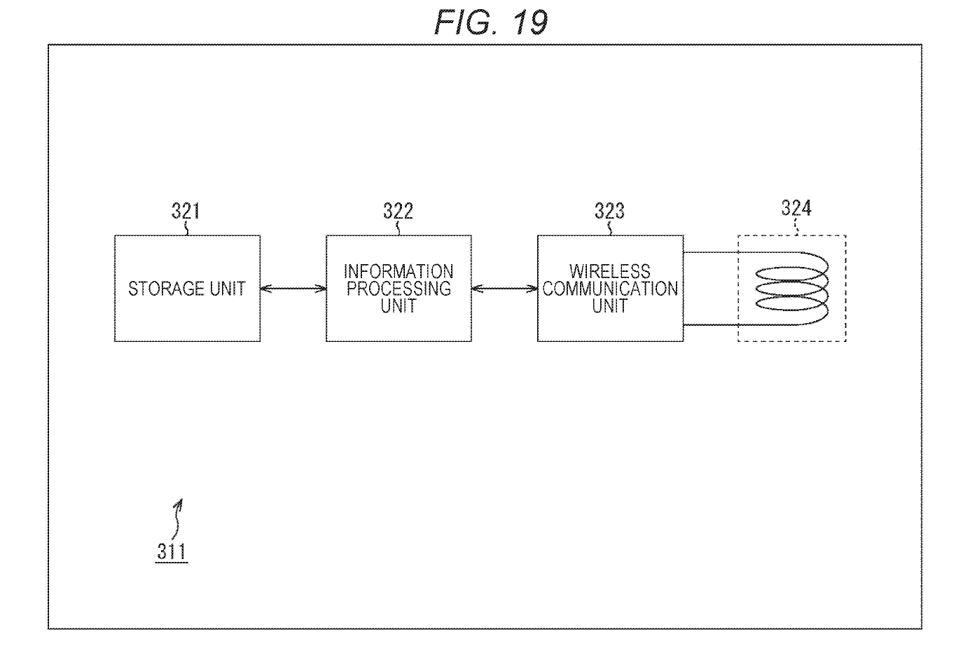

FIG. 19 is a block diagram showing a typical example configuration of an IC tag 311. As shown in FIG. 19, the IC tag 311 includes a storage unit 321, an information processing unit 322, a wireless communication unit 323, and an antenna 324.

The storage unit 321 stores various kinds of information, such as programs and data. For example, the storage unit 321 stores information that has been input beforehand at the factory. The storage unit 321 also stores information supplied from the information processing unit 322, for example. The storage unit 321 also supplies stored information to the information processing unit 322 as appropriate.

The information processing unit 322 executes a program, or processes various kinds of information. The information processing unit 322 also controls the storage unit 321 to store information thereinto, or reads information stored in the storage unit 321. The information processing unit 322 further controls the wireless communication unit 323, and causes the wireless communication unit 323 to communicate with another device and receive information transmitted from the device or transmit information to the device.

The wireless communication unit 323 performs near field communication with another device in a predetermined frequency band via the antenna 324. The wireless communication unit 323 acquires information from the device on the other end of the near field communication and supplies the information to the information processing unit 322, or transmits information supplied from the information processing unit 322 to the other device through the near field communication.

The IC tag 311 may of course be designed to have a configuration other than the configuration shown in FIG. 19.

<Physical Configuration of the IC Tag Reader>

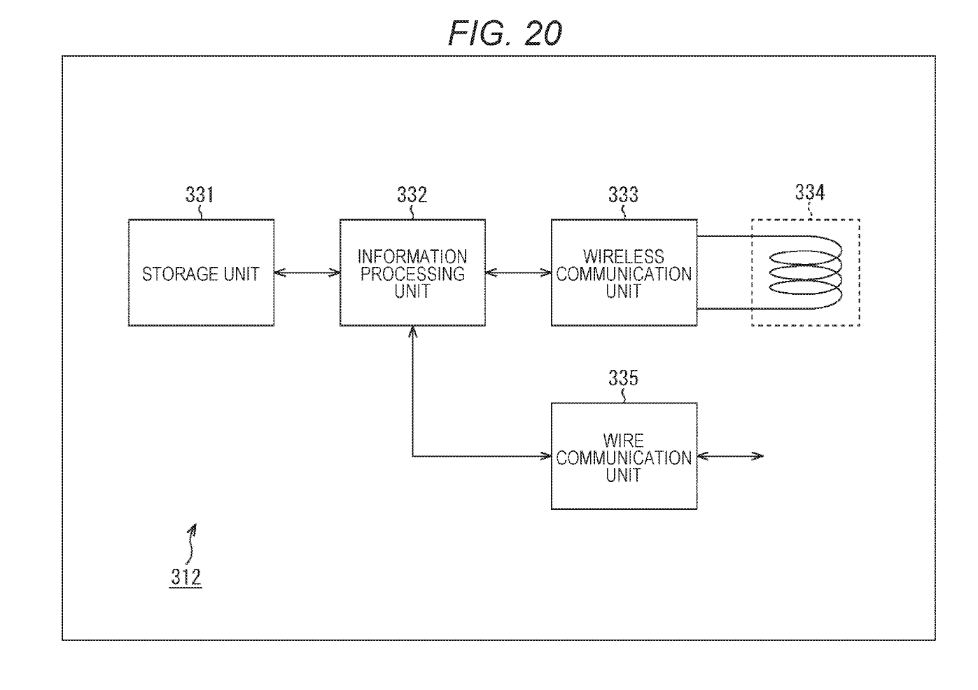

FIG. 20 is a block diagram showing a typical example configuration of the IC tag reader 312. As shown in FIG. 20, the IC tag reader 312 includes a storage unit 331, an information processing unit 332, a wireless communication unit 333, an antenna 334, and a wire communication unit 335.

The storage unit 331 stores various kinds of information, such as programs and data. For example, the storage unit 331 stores information that has been input beforehand at the factory. The storage unit 331 also stores information supplied from the information processing unit 332, for example. The storage unit 331 also supplies stored information to the information processing unit 332 as appropriate.

The information processing unit 332 executes a program, or processes various kinds of information. The information processing unit 332 also controls the storage unit 331 to store information thereinto, or reads information stored in the storage unit 331. The information processing unit 332 further controls the wireless communication unit 333, and causes the wireless communication unit 333 to communicate with another device and receive information transmitted from the device or transmit information to the device. The information processing unit 332 also controls the wire communication unit 335, and causes the wire communication unit 335 to perform communication (wire communication) with another device through a communication cable (wire) not shown in the drawing and receive information transmitted from the device or transmit information to the device.

The wireless communication unit 333 performs near field communication with another device in a predetermined frequency band via the antenna 334. The wireless communication unit 333 acquires information from the device on the other end of the near field communication and supplies the information to the information processing unit 332, or transmits information supplied from the information processing unit 332 to the other device through the near field communication.

The wire communication unit 335 performs communication (wire communication) with another device through a communication cable (wire) not shown in the drawing. The wire communication unit 335 acquires information from the library server 112 on the other end of the wire communication and supplies the information to the information processing unit 332, or transmits information supplied from the information processing unit 332 to the library server 112 through the wire communication.

<Configurations of Functional Blocks>

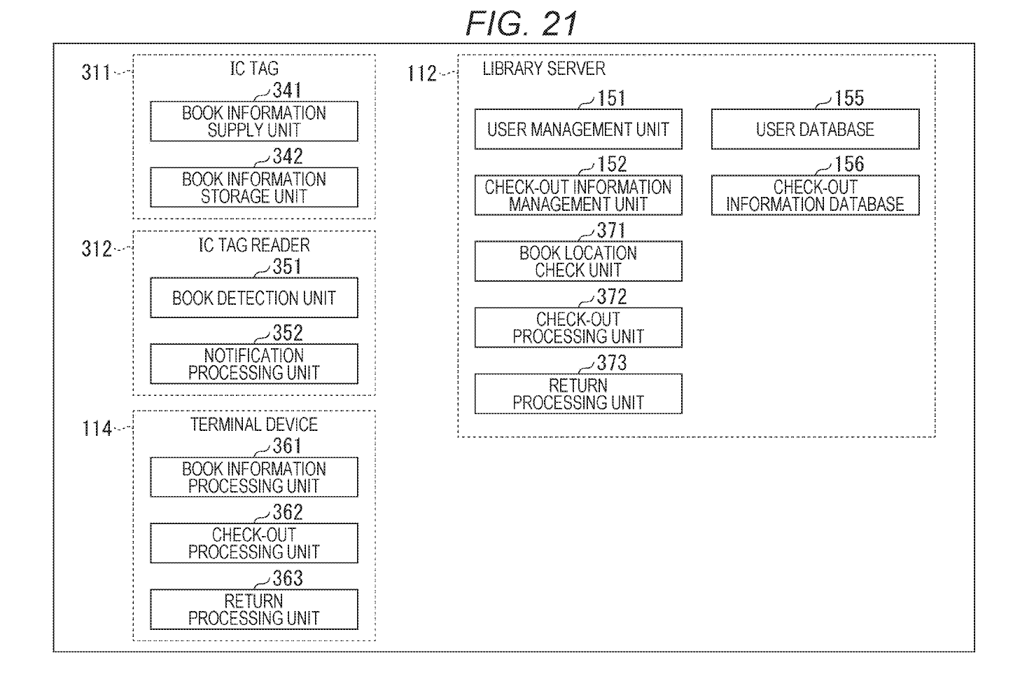

Next, the functions to be achieved by the respective devices of the IC tag 311, the IC tag reader 312, the library server 112, and the terminal device 114 in this book lending service system 300 are described. FIG. 21 is a functional block diagram showing typical example functions to be achieved by the respective devices.

As shown in FIG. 21, the IC tag 311 forms functional blocks such as a book information supply unit 341 and a book information storage unit 342. The book information storage unit 342 stores the book information about the book to which the IC tag 311 is attached. The contents of this book information is set as appropriate, and may include the name of the book, the name of the author, the publisher, the ISBN, the European Article Number (EAN), the date of publication, and a summary, for example. This book information storage unit 342 is formed in the storage unit 321 of the IC tag 311.

The book information supply unit 341 reads the book information stored in the book information storage unit 342, and supplies the book information to the other end of near field communication (non-contact communication). As the information processing unit 322 of the IC tag 311 executes a program, these functions are achieved.

Meanwhile, the IC tag reader 312 forms functional blocks such as a book detection unit 351 and a notification processing unit 352. The book detection unit 351 detects an IC tag 311 located in the vicinity (located within the range of communication) through near field communication (non-contact communication). Any appropriate detection may be used. For example, the book detection unit 351 reads book information through near field communication, to detect an IC tag 311 located in the vicinity. If the book information reading is successful, the book detection unit 351 determines that an IC tag 311 (a book) exists in the vicinity. If the book information reading is unsuccessful, the book detection unit 351 determines that no IC tags 311 (books) exist in the vicinity.

The notification processing unit 352 notifies the library server 112 of a result of detection of a nearby IC tag 311 (a book) detected by the book detection unit 351, through the wire communication unit 335, for example. For example, in a case where the book detection unit 351 has succeeded in the book information reading, the notification processing unit 352 notifies the library server 112, through the wire communication unit 335, that an IC tag 311 (a book) located in the vicinity has been detected. In doing so, the notification processing unit 352 supplies the book information read by the book detection unit 351 to the library server 112. Also, in a case where the book detection unit 351 has failed in the book information reading, on the other hand, the notification processing unit 352 notifies the library server 112, through the wire communication unit 335, that any IC tag 311 (any book) located in the vicinity has not been detected, for example.

As the information processing unit 332 of the IC tag reader 312 executes a program, these functions are achieved.

Further, the library server 112 forms functional blocks such as a user management unit 151, a check-out information management unit 152, a book location check unit 371, a check-out processing unit 372, a return processing unit 373, a user database 155, and a check-out information database 156.

The book location check unit 371 performs processing related to checking of a book location, using a result of detection of an IC tag 311. The check-out processing unit 372 performs processing related to lending of a book. The return processing unit 373 performs processing related to returning of a book. As the CPU 121 of the library server 112 executes a program, these functions are achieved.

Meanwhile, the terminal device 114 forms functional blocks such as a book information processing unit 361, a check-out processing unit 362, and a return processing unit 363. The book information processing unit 361 performs processing related to book information, such as reading book information from an IC tag 311 by using a function of the NFC 114A, for example. The check-out processing unit 362 performs processing related to lending of a book. The return processing unit 363 performs processing related to returning of a book. As the CPU 121 of the terminal device 114 executes a program (an application supplied from a mobile book-reading account server 113, for example), these functions are achieved.

<Flow of Processing Related to Lending>

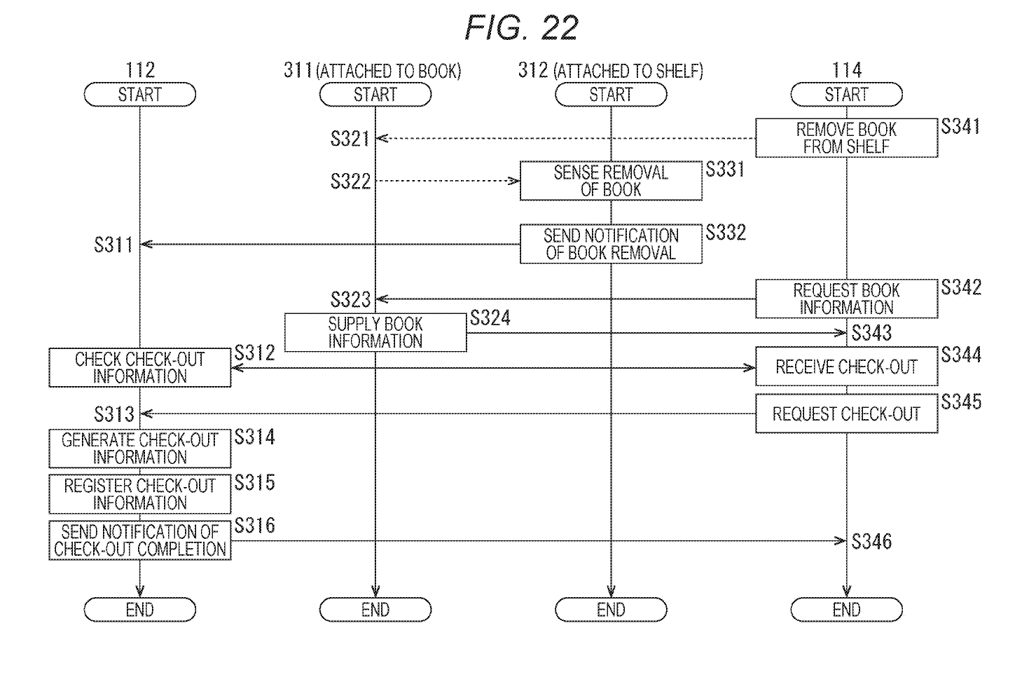

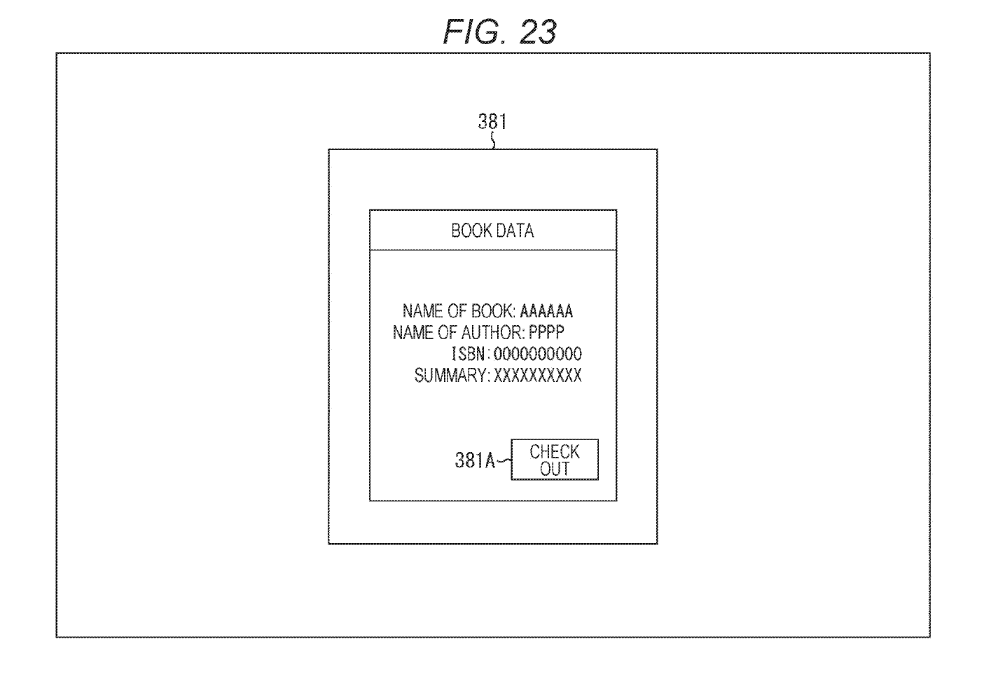

Next, flows in various processes to be performed by the book lending service system 300 shown in FIG. 18 are described. Referring now to the flowchart in FIG. 22, the flow of processing related to lending of a book in a book lending service is described. The explanation will also be made with reference to FIG. 23 as necessary.

To borrow the book 301, the user 103 first removes the book 301 from the bookshelf (step S341). As a result, the IC tag 311 of the book 301 is moved away from the IC tag reader 312 on the bookshelf (step S321 and step S322). Therefore, the book detection unit 351 of the IC tag reader 312 fails in reading the book information from the IC tag 311 through near field communication performed by the wireless communication unit 333, and thus, detects the removal of the book 301 (step S331). In step S332, the notification processing unit 352 of the IC tag reader 312 notifies the library server 112 of the removal of the book 301 via the wire communication unit 335. In step S311, the book location check unit 371 of the library server 112 acquires the notification through the communication unit 134 of the library server 112.

The user 103 then brings the book 301 (the IC tag 311), which has been removed from the bookshelf, close to the terminal device 114, so that the book information is read by the terminal device 114. As the book 301 is brought close to the terminal device 114, the book information processing unit 361 of the terminal device 114 requests the book information from the IC tag 311 through near field communication performed by the NFC 114A of the communication unit 134 of the terminal device 114, and then acquires the book information (step S342 and step S343). Meanwhile, the book information supply unit 341 of the IC tag 311 acquires the request through near field communication performed by the wireless communication unit 323. In accordance with the acquired request, the book information supply unit 341 reads the book information from the book information storage unit 342 of the storage unit 321, and supplies the read book information to the terminal device 114 through near field communication performed by the wireless communication unit 323 (step S323 and step S324).

Next, in step S344, the check-out processing unit 362 of the terminal device 114 receives a check-out instruction input from the user 103 or the like. The check-out processing unit 362 first communicates with the library server 112 via the communication unit 134 of the terminal device 114, and causes the library server 112 to check the check-out information. In step S312, in accordance with the request, the check-out information management unit 152 of the library server 112 checks the check-out information in the check-out information database 156, and determines whether the book 301 can be lent out. In this step, the book location check unit 371 of the library server 112 also determines whether the book 301 has been removed from the bookshelf. The check-out information management unit 152 notifies the terminal device 114 of the results of the checking through the communication unit 134 of the library server 112.

In a case where the book 301 can be lent out but has been removed from the bookshelf, the check-out processing unit 362 causes (the display unit of) the output unit 132 of the terminal device 114 to display a check-out reception image 381 (in a pop-up window) as shown in FIG. 23.

In FIG. 23, the check-out reception image 381 shows the message “Book Data” indicating that the information is book information, and the book information about the book 301. This book information is information read from the book information storage unit 342, and includes the name of the book, the name of the author, the ISBN, and a summary, for example.

The check-out reception image 381 also shows a check-out GUI button 381A. When the user 103 operates this check-out GUI button 381A (or taps the screen, for example), a request for the check-out procedures for the book 301 (or a check-out instruction input from the user 103 or the like) is received. That is, by detecting an operation performed by the user 103 or the like on the check-out GUI button 381A, the check-out processing unit 362 receives a check-out instruction input for the book 301 from the user 103 or the like.

After receiving the check-out instruction input, the check-out processing unit 362 requests lending of the book 301 from the library server 112 through the communication unit 134 of the terminal device 114 in step S345. In making the request, the check-out processing unit 362 supplies the library server 112 with the information necessary for the procedures related to the lending, such as the book information about the book 301 and the user information about the user 103.

After receiving the request through the communication unit 134 of the library server 112 in step S313, the check-out processing unit 372 of the library server 112 generates check-out information about the requested book 301, using the supplied book information and user information. The check-out processing unit 372 then registers the generated check-out information into the check-out information database 156, and notifies the terminal device 114 of the completion of the procedures related to the lending (check-out completion) through the communication unit 134 of the library server 112 (steps S314 through S316).

In step S346, the check-out processing unit 362 of the terminal device 114 receives the notification through the communication unit 134 of the terminal device 114.

In the above manner, processing related to lending of a book is performed. Accordingly, it is possible to simplify the procedures necessary for lending, such as inputting book information and user information, associating the book information with the user information, and generating check-out information. That is, check-out information can be more easily managed. Thus, the convenience of the lending service can be enhanced.

<Flow of Processing Related to Returning>

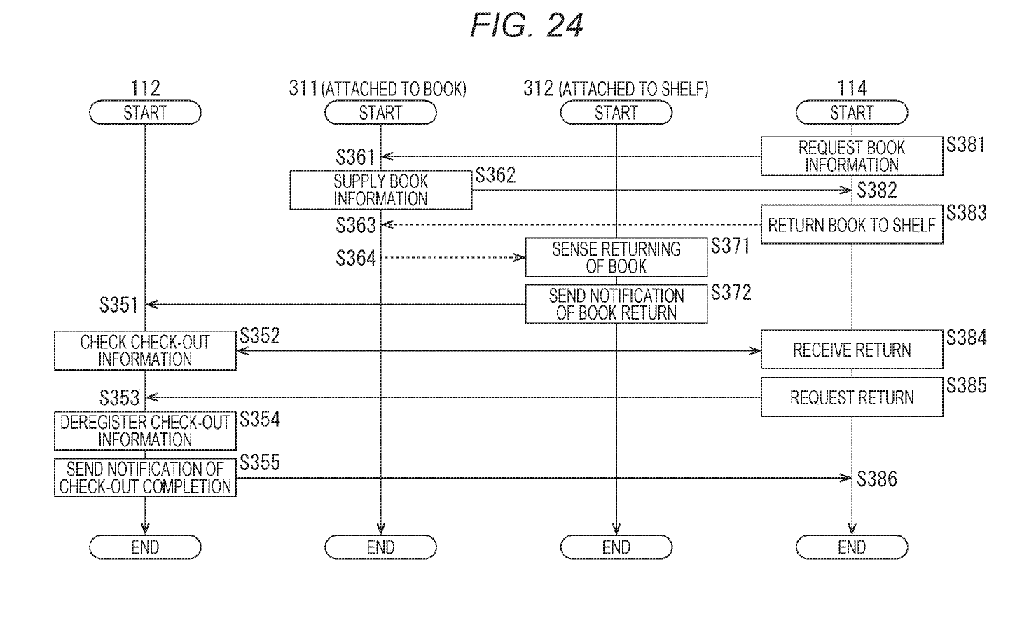

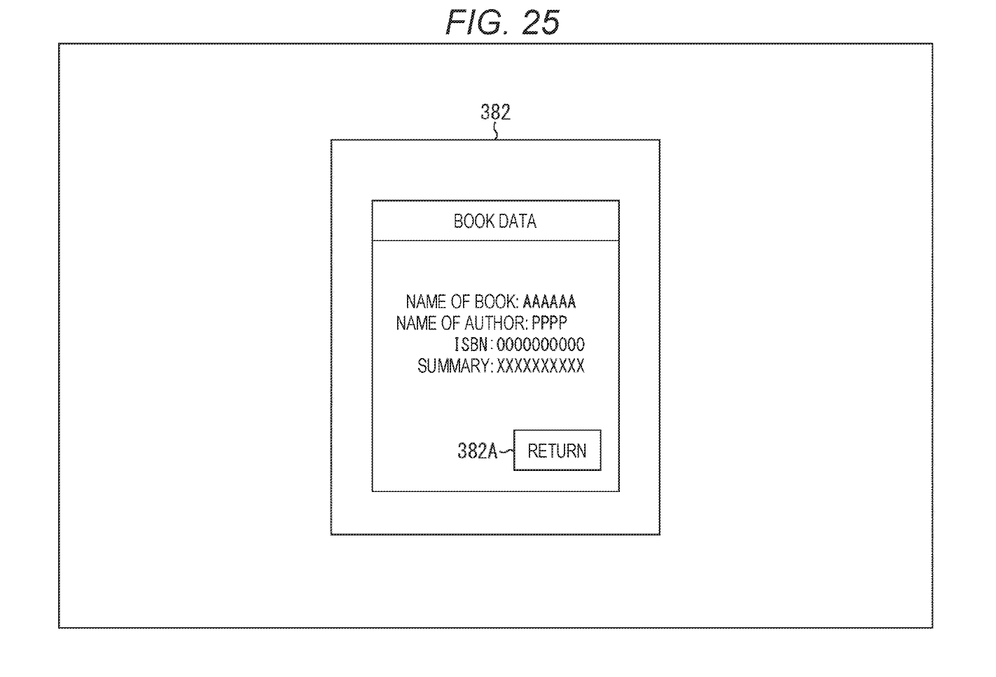

Referring now to the flowchart in FIG. 24, the flow of processing related to returning of a book in the book lending service is described. The explanation will also be made with reference to FIG. 25 as necessary.

To return a book, the user 103 first brings the book 301 to be returned close to the terminal device 114, so that the book information is read by the terminal device 114. As the book 301 is brought close to the terminal device 114, the book information processing unit 361 of the terminal device 114 requests the book information from the IC tag 311 through near field communication performed by the NFC 114A of the communication unit 134 of the terminal device 114, and then acquires the book information (step S381 and step S382). Meanwhile, the book information supply unit 341 of the IC tag 311 acquires the request through near field communication performed by the wireless communication unit 323. In accordance with the acquired request, the book information supply unit 341 reads the book information from the book information storage unit 342 of the storage unit 321, and supplies the read book information to the terminal device 114 through near field communication performed by the wireless communication unit 323 (step S361 and step S362).

The user 103 then returns the book 301 onto the bookshelf (step S383). As a result, the IC tag 311 of the book 301 is brought close to the IC tag reader 312 on the bookshelf (step S363 and step S364). Therefore, the book detection unit 351 of the IC tag reader 312 succeeds in reading the book information from the IC tag 311 through near field communication performed by the wireless communication unit 333, and thus, detects the returning of the book 301 (step S371). In step S372, the notification processing unit 352 of the IC tag reader 312 notifies the library server 112 of the returning of the book via the wire communication unit 335. In step S351, the book location check unit 371 of the library server 112 acquires the notification through the communication unit 134 of the library server 112.

Next, in step S384, the return processing unit 363 of the terminal device 114 receives a return instruction input from the user 103 or the like. The return processing unit 363 first communicates with the library server 112 via the communication unit 134 of the terminal device 114, and causes the library server 112 to check the check-out information. In step S352, in accordance with the request, the check-out information management unit 152 of the library server 112 checks the check-out information in the check-out information database 156, and determines whether the book 301 is checked out. In this step, the book location check unit 371 of the library server 112 also determines whether the book 301 has been returned to a predetermined location on the bookshelf. The check-out information management unit 152 notifies the terminal device 114 of the results of the checking through the communication unit 134 of the library server 112.

In a case where the book 301 is in a checked-out state but has been returned to the predetermined location on the bookshelf, the return processing unit 363 causes (the display unit of) the output unit 132 of the terminal device 114 to display a return reception image 382 (in a pop-up window) as shown in FIG. 25.

In FIG. 25, the return reception image 382 shows the message “Book Data” indicating that the information is book information, and the book information about the book 301. This book information is information read from the book information storage unit 342, and includes the name of the book, the name of the author, the ISBN, and a summary, for example.

The return reception image 382 also shows a return GUI button 382A. When the user 103 operates this return GUI button 382A (or taps the screen, for example), a request for the return procedures for the book 301 (or a return instruction input from the user 103 or the like) is received. That is, by detecting an operation performed by the user 103 or the like on the return GUI button 382A, the return processing unit 363 receives a return instruction input for the book 301 from the user 103 or the like.

After receiving the return instruction input, the return processing unit 363 requests returning of the book 301 from the library server 112 through the communication unit 134 of the terminal device 114 in step S385. In making the request, the return processing unit 363 supplies the library server 112 with the information necessary for the procedures related to the returning, such as the book information about the book 301 and the user information about the user 103.

After receiving the request through the communication unit 134 of the library server 112 in step S353, the return processing unit 373 of the library server 112 deregisters the check-out information about the requested book in the check-out information database 156, using the supplied book information and user information. The return processing unit 373 then notifies the terminal device 114 of the completion of the procedures related to the returning (return completion) through the communication unit 134 of the library server 112 (step S354 and step S355).

In step S386, the return processing unit 363 of the terminal device 114 receives the notification through the communication unit 134 of the terminal device 114.

In the above manner, processing related to returning of a book is performed. Accordingly, it is possible to simplify the procedures necessary for returning of a book, such as inputting book information and user information, associating the book information with the user information, and deregistering the check-out information. That is, check-out information can be more easily managed. Thus, the convenience of the lending service can be enhanced.

It should be noted that the book lending service system 100 described in the first embodiment may be combined with the book lending service system 300 described in the second embodiment. For example, the method of lending and returning a book in the book lending service system 300 described in the second embodiment may be used in the book lending service system 100, instead of the method described with reference to the flowchart in FIG. 6. In this manner, the convenience of the lending service can be further enhanced.

### 3. Third Embodiment

<Book Lending Service System>

It should be noted that, when using a mobile book-reading account service that provides aid in a book lending service as described above, a user 103 may need to log in to a mobile book-reading account server 113 (or need to go through an authentication process) using a terminal device 114. Furthermore, in the log-in procedure (authentication process), both the user 103 and the terminal device 114 may need to be authenticated.

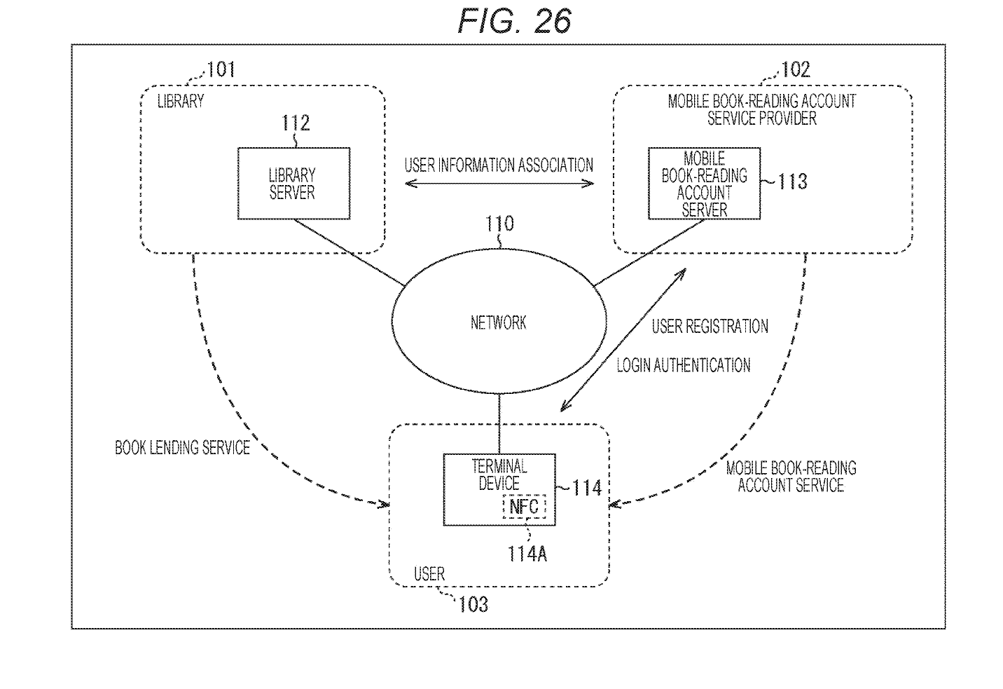

FIG. 26 is a diagram for explaining the outline of a book lending service system that is an embodiment of an information processing system to which the present technology is applied. Like the book lending service system 100 (FIG. 1) and the book lending service system 300 (FIG. 18), the book lending service system 400 shown in FIG. 26 is a system that provides aid in a lending service to be provided by a library 101 to lend out books (published books).

The user 103 uses the book lending service being provided by the library 101, and also uses the mobile book-reading account service being provided by the mobile book-reading account service provider 102. To use this mobile book-reading account service, both the user and the terminal device need to be authenticated. Specifically, in the example case shown in FIG. 26, IDs and passwords are (registered and) assigned to the user 103 and the terminal device 114 before the use of the mobile book-reading account service. Before the mobile book-reading account service is used, it is necessary to log in to the mobile book-reading account server 113, and the ID and the password of the user, and the ID and the password of the terminal device need to be authenticated for the login. In the description below, authentication of the ID and the password of the user, and authentication of the ID and the password of the terminal device will be also collectively referred to as “two-step authentication”.

For the two-step authentication, the ID (user ID) and the password of the user, and the ID (terminal device ID) and the password of the terminal device are set at the time of user registration with the mobile book-reading account server 113. The user ID and the password are determined by any appropriate method. For example, the mobile book-reading account server 113 may designate them, or the user 103 may designate them.

As for the terminal device ID, information that is set beforehand in the terminal device 114 and is related to the terminal device 114 is used. For example, the terminal device 114 has an NFC 114A as a communication function of the communication unit 134, and can perform non-contact communication (near field communication) with an NFC device located in the vicinity, using the functions of the NFC 114A, as in the case shown in FIG. 26. The NFC 114A is formed as an independent communication device such as a chip or a module, and has unique information such as an ID stored beforehand in an internal storage unit. For example, the terminal device 114 may use the information unique to the NFC 114A as the terminal device ID. The terminal device 114 may use an ID assigned to the NFC 114A at the factory as the terminal device ID, for example.

The password to be associated with the terminal device ID is determined by any appropriate method. For example, the mobile book-reading account server 113 may designate it, or the user 103 may designate it.

That is, before using the mobile book-reading account service, the user 103 needs to log in to the mobile book-reading account server 113, using the terminal device 114. In other words, an application that has been provided by the mobile book-reading account server 113 and been installed into the terminal device 114 accesses the mobile book-reading account server 113, and causes the mobile book-reading account server 113 to perform the above described two-step authentication before the login.

The mobile book-reading account server 113 registers the user ID and the password of the user 103 of the book lending service, and the terminal device ID and the password (user registration). The mobile book-reading account server 113 also accepts a login of the user 103 for whom the user registration has been conducted, and performs the two-step authentication. The mobile book-reading account server 113 further provides the mobile book-reading account service to the logged in user 103.

It should be noted that, at the time of user registration for the mobile book-reading account service, the mobile book-reading account server 113 associates the information about the user of the mobile book-reading account service with the information about the user of the book lending service being managed by the library server 112.

<Configurations of Functional Blocks>

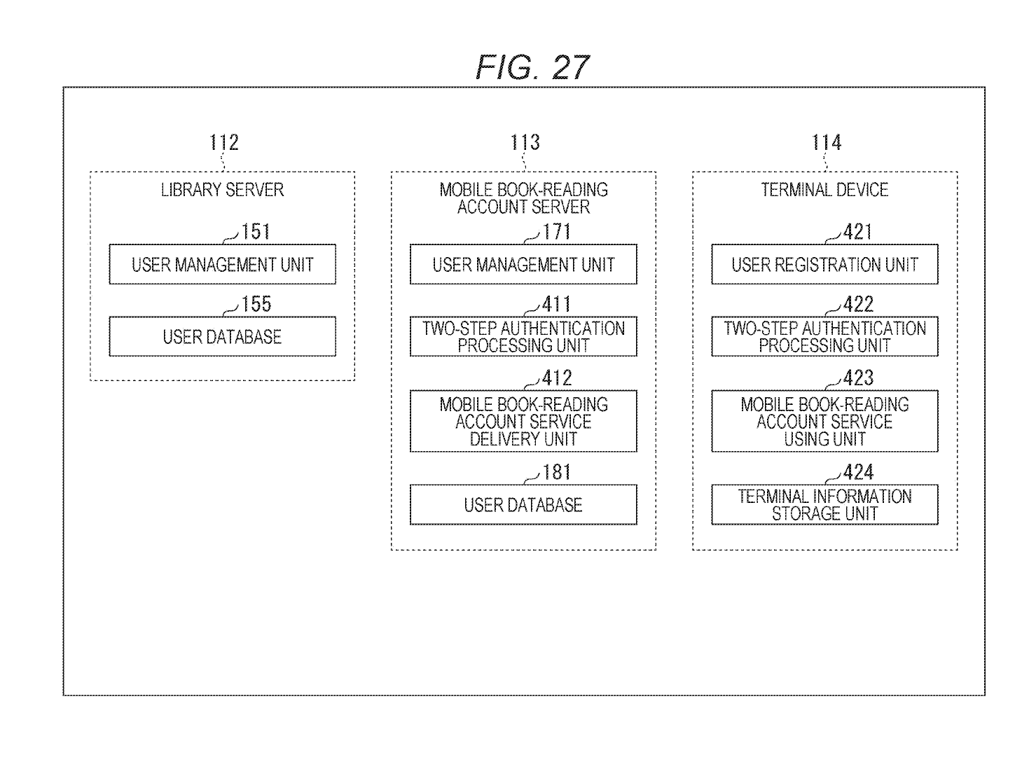

Next, the functions to be achieved by the respective devices of the library server 112, the mobile book-reading account server 113, and the terminal device 114 in this book lending service system 400 are described. FIG. 27 is a functional block diagram showing typical example functions to be achieved by the respective devices.

As shown in FIG. 27, the library server 112 forms functional blocks such as a user management unit 151 and a user database 155.

Meanwhile, the mobile book-reading account server 113 forms functional blocks such as a user management unit 171, a two-step authentication processing unit 411, a mobile book-reading account service delivery unit 412, and a user database 181. The two-step authentication processing unit 411 performs processing related to the two-step authentication to be conducted when the user 103 (the terminal device 114) logs in. The mobile book-reading account service delivery unit 412 performs processing related to the mobile book-reading account service. As the CPU 121 of the mobile book-reading account server 113 executes a program, the functions such as the two-step authentication processing unit 411 and the mobile book-reading account service delivery unit 412 are achieved.

Also, the terminal device 114 forms functional blocks such as a user registration unit 421, a two-step authentication processing unit 422, a mobile book-reading account service using unit 423, and a terminal information storage unit 424. The user registration unit 421 performs processing related to registration of information about the user 103 and the terminal device 114. The two-step authentication processing unit 422 performs processing related to the two-step authentication to be conducted to log in to the mobile book-reading account server 113. The mobile book-reading account service using unit 423 performs processing related to use of the mobile book-reading account service. As the CPU 121 of the terminal device 114 executes a program (an application supplied from the mobile book-reading account server 113, for example), the functions such as the user registration unit 421, the two-step authentication processing unit 422, and the mobile book-reading account service using unit 423 are achieved.

The terminal information storage unit 424 stores terminal information that is the information about the terminal device 114, and the like. The terminal information includes the ID assigned beforehand to the NFC 114A of the terminal device 114 at the factory, for example. The terminal information storage unit 424 is formed in the storage unit 133 of the mobile book-reading account server 113.

<Flow of Processing Related to User Registration>

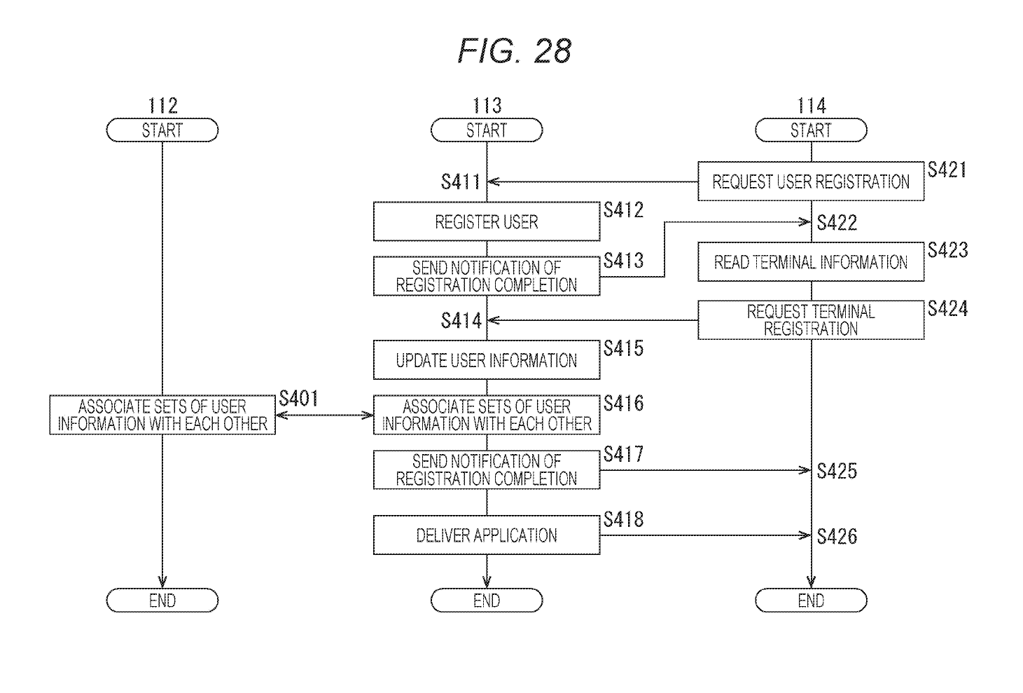

Next, flows in various processes to be performed by the book lending service system 400 shown in FIG. 26 are described. Referring now to the flowchart in FIG. 28, the flow of processing related to user registration for the mobile book-reading account service is described.

In the user registration for the mobile book-reading account service, the user ID and the password are first set.

In step S421, the user registration unit 421 of the terminal device 114 transmits and supplies the information necessary for the user registration to the mobile book-reading account server 113 through the communication unit 134 of the terminal device 114, and requests the user registration. The information necessary for the user registration includes the user ID and the password that have been set (input) by the user 103, for example. The information necessary for the user registration may also include any appropriate information other than the user ID and the password. Also, the user ID and/or the password may be set by (an application or the like executed in) the terminal device 114. It should be noted that the user ID and/or the password may be set by the mobile book-reading account server 113. In that case, the user ID and the password may, of course, not be included in the information necessary for the user registration.

In step S411, the user management unit 171 of the mobile book-reading account server 113 obtains the information through the communication unit 134 of the mobile book-reading account server 113. In step S412, using the obtained information, the user management unit 171 generates user information about the user 103, and registers the user information in the user database 181. This user information includes at least the user ID and the password that have been set.

When the registration is completed, the user management unit 171 of the mobile book-reading account server 113 notifies the terminal device 114 of the completion of the user registration through the communication unit 134 of the mobile book-reading account server 113 in step S413. In step S422, the user registration unit 421 of the terminal device 114 receives the notification through the communication unit 134 of the terminal device 114. This notification may include the user ID and the password that have been set.

The terminal device ID and the password are then set, for example. As described above, the ID assigned beforehand to the NFC 114A is used as the terminal device ID.

In step S423, the user registration unit 421 of the terminal device 114 reads the terminal information as the information about the terminal device 114, from the storage unit 133 of the terminal device 114. This terminal information includes at least the ID assigned beforehand to the NFC 114A. The user registration unit 421 also receives an input of the password associated with the terminal device ID from the user 103, for example, and incorporates the received password into the terminal information.

In step S424, the user registration unit 421 transmits and supplies the terminal information including the terminal device ID and the password to the mobile book-reading account server 113 through the communication unit 134 of the terminal device 114, and requests registration of the terminal device (terminal registration). This terminal information may also include any appropriate information other than the terminal device ID and the password. It should be noted that the password to be associated with the terminal device ID may be set by (an application or the like executed in) the terminal device 114. It should be noted that the password may be set by the mobile book-reading account server 113. In that case, the password may, of course, not be included in the terminal information.

In step S414, the user management unit 171 of the mobile book-reading account server 113 obtains the information through the communication unit 134 of the mobile book-reading account server 113. In step S415, using the obtained information, the user management unit 171 updates the user information in the user database 181. That is, the terminal information and the like are added to the user information about the user 103 stored in the user database 181. The resultant user information includes at least the user ID and the corresponding password, and the terminal device ID and the corresponding password.

The user management unit 151 of the library server 112 and the user management unit 171 of the mobile book-reading account server 113 exchange information with each other through the respective communication units 134, and link (associate) the sets of user information with each other (step S401 and step S416). For example, the user management unit 151 and the user management unit 171 associate the sets of user information about the same user with each other.

When the terminal registration is completed as above, the user management unit 171 of the mobile book-reading account server 113 notifies the terminal device 114 of the completion of the terminal registration through the communication unit 134 of the mobile book-reading account server 113 in step S417. In step S425, the user registration unit 421 of the terminal device 114 receives the notification through the communication unit 134 of the terminal device 114. This notification may include the terminal device ID and the password that have been set.

When the user and terminal device registration for the mobile book-reading account service is completed, the application delivery unit 172 of the mobile book-reading account server 113 in step S418 transmits and supplies an application dealing with various kinds of information related to book lending, to the terminal device 114 through the communication unit 134 of the mobile book-reading account server 113 at a predetermined time. In step S426, the user registration unit 191 of the terminal device 114 obtains the application through the communication unit 134 of the terminal device 114. The obtained application is installed into the storage unit 133.

In the above manner, user registration for the mobile book-reading account service is conducted. With this, user registration can be more readily conducted. Also, as both the user and the terminal device are registered, two-step authentication can be conducted at the time of a login. With this, not only the user but also the terminal device to be used by the user to log in can be authenticated. Thus, unauthorized logins or unauthorized use of the mobile book-reading account service can be reduced. That is, the mobile book-reading account service provider 102 (the mobile book-reading account server 113) can realize (provide) a safer mobile book-reading account service, and the user 103 (the terminal device 114) can more safely use the mobile book-reading account service. Furthermore, the user information in the book lending service and the user information in the mobile book-reading account service can be more easily associated with each other. Thus, the convenience of the lending service can be enhanced.

<Flow of Processing Related to a Login>

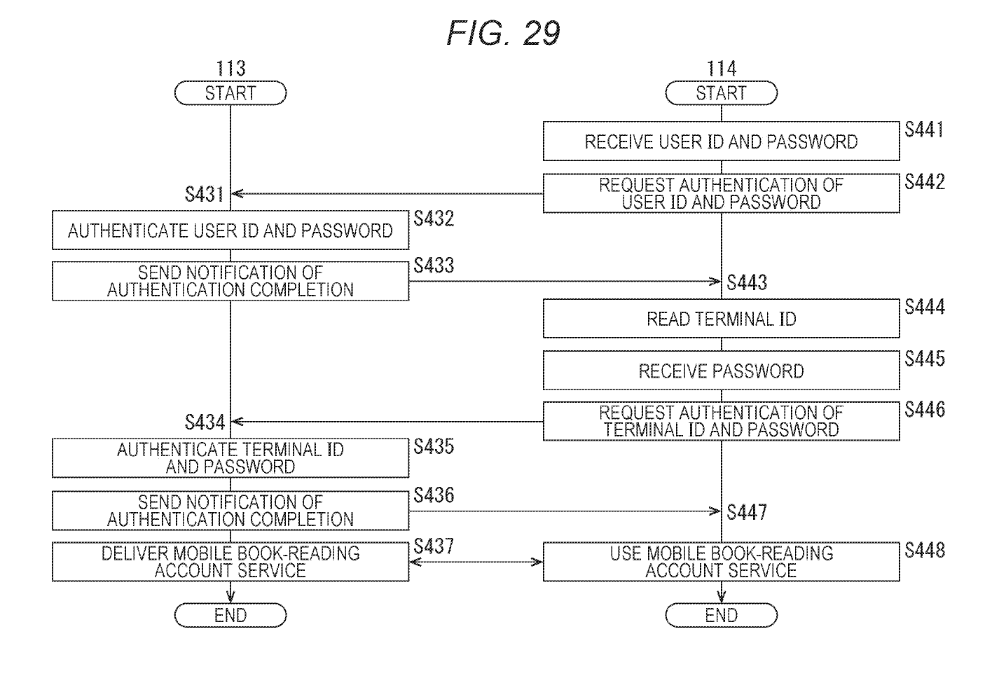

Referring now to the flowchart in FIG. 29, the flow of processing related to a login of the terminal device 114 to the mobile book-reading account server 113 is described.

As described above, before a user 103 uses the mobile book-reading account service, the user 103 logs in to the mobile book-reading account server 113, using the terminal device 114. Then, in this process, the mobile book-reading account server 113 authenticates the IDs and the passwords of both the user 103 and the terminal device 114 (or conducts two-step authentication).

In the two-step authentication, the ID and the password of the user are first authenticated. In step S441, the two-step authentication processing unit 422 of the terminal device 114 receives an input of the user ID and the password from the user 103 or the like operating the input unit 131 of the terminal device 114.

In step S442, the two-step authentication processing unit 422 transmits and supplies the received user ID and password to the mobile book-reading account server 113 through the communication unit 134 of the terminal device 114, and requests authentication of the user ID and the password. It should be noted that, in making the request, the two-step authentication processing unit 422 may supply the mobile book-reading account server 113 with information other than the user ID and the password.

In step S431, the two-step authentication processing unit 411 of the mobile book-reading account server 113 obtains the information through the communication unit 134 of the mobile book-reading account server 113. In step S432, the two-step authentication processing unit 411 authenticates the obtained user ID and password, using the user information stored in the user database 181.

After the user ID and the password are authenticated, the two-step authentication processing unit 411 of the mobile book-reading account server 113 notifies the terminal device 114 of the completion of authentication of the user 103 through the communication unit 134 of the mobile book-reading account server 113 in step S433.

In step S443, the two-step authentication processing unit 422 of the terminal device 114 receives the notification through the communication unit 134 of the terminal device 114.

The ID and the password of the terminal device are then authenticated. In step S444, the two-step authentication processing unit 422 of the terminal device 114 reads the terminal device ID (the ID assigned to the NFC 114A, for example) from the terminal information storage unit 424. In step S445, the two-step authentication processing unit 422 also receives an input of the password associated with the terminal device ID from the user 103 or the like operating the input unit 131 of the terminal device 114.

In step S446, the two-step authentication processing unit 422 transmits and supplies the read terminal device ID and the received password to the mobile book-reading account server 113 through the communication unit 134 of the terminal device 114, and requests authentication of the terminal device ID and the password. It should be noted that, in making the request, the two-step authentication processing unit 422 may supply the mobile book-reading account server 113 with information other than the terminal device ID and the password.

In step S434, the two-step authentication processing unit 411 of the mobile book-reading account server 113 obtains the information through the communication unit 134 of the mobile book-reading account server 113. In step S435, the two-step authentication processing unit 411 authenticates the obtained terminal device ID and password, using the user information stored in the user database 181.

After the terminal device ID and the password are authenticated, the two-step authentication processing unit 411 of the mobile book-reading account server 113 notifies the terminal device 114 of the completion of authentication of the terminal device 114 through the communication unit 134 of the mobile book-reading account server 113 in step S436.

In step S447, the two-step authentication processing unit 422 of the terminal device 114 receives the notification through the communication unit 134 of the terminal device 114.

After two-step authentication is conducted as above, and both the user 103 and the terminal device 114 are authenticated, a login is successfully performed, and the mobile book-reading account service can be provided.

Specifically, in step S437, the mobile book-reading account service delivery unit 412 of the mobile book-reading account server 113 communicates with the terminal device 114 via the communication unit 134 of the mobile book-reading account server 113, and provides various services in the mobile book-reading account service to the logged in terminal device 114 (or the user 103 operating the terminal device 114).

In step S448, the mobile book-reading account service using unit 423 of the terminal device 114 communicates with the mobile book-reading account server 113 via the communication unit 134 of the terminal device 114, and uses the provided various services in the mobile book-reading account service.

In the above manner, processing related to a login using two-step authentication is performed. Because of this, at the time of a login, the user and the terminal device to be used by the user to log in need to be authenticated. For example, even if the ID and the password of the user are leaked to outsiders, it is not possible to log in with the ID and the password of the user from another terminal device, since the ID and the password of the corresponding terminal device are also required at the time of a login. Thus, unauthorized logins or unauthorized use of the mobile book-reading account service can be reduced. That is, the mobile book-reading account service provider 102 (the mobile book-reading account server 113) can realize (provide) a safer mobile book-reading account service, and the user 103 (the terminal device 114) can more safely use the mobile book-reading account service. Thus, the convenience of the lending service can be enhanced.

Also, in the terminal device 114, an application supplied from the mobile book-reading account server 113 performs processing such as acquiring the terminal device ID and requesting authentication. Accordingly, the user 103 can more easily cause the mobile book-reading account server 113 to perform a two-step authentication process, simply by inputting the user ID and the password, or the like. That is, the user 103 (the terminal device 114) can more easily and more safely use the mobile book-reading account service. Thus, the convenience of the lending service can be enhanced.

It should be noted that the contents of the mobile book-reading account service are determined as appropriate. For example, the various services described in the first embodiment may be included. Alternatively, services other than the above may be included.

That is, the book lending service system 400 described in the third embodiment may be combined with the book lending service system 100 described in the first embodiment or the book lending service system 300 described in the second embodiment, for example. In this manner, the convenience of the lending service can be further enhanced.

It should be noted that, although the ID assigned to the NFC 114A is used as the terminal device ID in the above described example, the terminal device ID may be other than the above ID, as long as the terminal device ID provides information from which the terminal device 114 can be identified. For example, the media access control (MAC) address assigned to the communication unit 134 of the terminal device 114 may be used as the terminal device ID. In that case, the terminal device 114 may not include the NFC 114A.

Alternatively, an ID and a password for the book lending service being provided by the library 101 may be used as the terminal device ID and the corresponding password.

In some cases, the NFC 114A in the terminal device 114 is used as a membership card (a digitized membership card) for the book lending service, for example. In such a case, the ID and the like for the book lending service are stored in the storage unit of the NFC 114A, and the ID and like are read by a reader installed at the library 101 through near field communication (non-contact communication). Authentication is then conducted.

In a case where such digitized membership cards are used in the book lending service of the library 101, electronic information registered beforehand in the NFC 114A or the ID and the like for the book lending service may be used as the terminal device ID and the like. That is, the above described ID assigned to the NFC 114A may be the ID of a digitized membership card for the book lending service. In this case, the password to be associated with the terminal device ID may be the password associated with the ID of the digitized membership card for the book lending service, or a new password may be set. Since the mobile book-reading account service is a different service from the book lending service, a common ID may be associated with different passwords from each other without any problem.

Also, part of or all of the processing to be performed by one of the devices described above may be performed by another device. For example, in the book lending service system 100, part of or all of the above described processing to be performed by the mobile book-reading account server 113 may be performed by the library server 112 or the terminal device 114. Also, part of or all of the above described processing to be performed by the library server 112 may be performed by the mobile book-reading account server 113 or the terminal device 114, for example. Further, part of or all of the above described processing to be performed by the terminal device 114 may be performed by the library server 112 or the mobile book-reading account server 113, for example.

Also, in the book lending service system 300, part of or all of the above described processing to be performed by the library server 112 may be performed by the terminal device 114, for example. Further, part of or all of the above described processing to be performed by the terminal device 114 may be performed by the library server 112, for example.

Also, in the book lending service system 400, part of or all of the above described processing to be performed by the library server 112 may be performed by the mobile book-reading account server 113 or the terminal device 114, for example. Further, part of or all of the above described processing to be performed by the mobile book-reading account server 113 may be performed by the library server 112 or the terminal device 114, for example. Also, part of or all of the above described processing to be performed by the terminal device 114 may be performed by the library server 112 or the mobile book-reading account server 113, for example.

Part of or all of the processing to be performed by any one of the devices described above may of course be performed by some other device not shown in the drawings.

Also, each of the devices may perform processing other than the above described processing.

That is, the functional blocks of each of the devices shown in FIGS. 3, 4, 21, 27, and others are merely an example, and each of the devices may form a functional block not shown in those examples. Also, each device may form a functional block to be formed by another device in the above described examples. Further, each device may not form one or all of the functional blocks to be formed by the device in the above described examples.

Furthermore, although a book lending service has been described above, the objects to be lent out in a lending service may be set as appropriate, and are not limited to books. The present technology can be applied to services of lending any appropriate objects.

<Software>

The above described series of processes may be performed either by hardware or by software. Where the above described series of processes are to be performed by software, the program that forms the software is installed from a network or a recording medium.

This recording medium is formed with the removable medium 136 that is distributed to deliver the program to users separately from devices, and has the program recorded therein, as shown in FIG. 2, for example. This removable medium 136 includes a magnetic disk (including a flexible disk) and an optical disk (including a CD-ROM and a DVD). Further, a magnetooptical disk (including a Mini Disc (MD)), a semiconductor memory, and the like are included.

For example, in each of the devices such as the library terminal device 111, the library server 112, the mobile book-reading account server 113, the terminal device 114, and the bookselling server 115, the removable medium 136 is mounted on the drive 135 so that this program stored in the removable medium 136 can be read and installed into the storage unit 133. Also, in the IC tag reader 312, for example, a removable medium (not shown) is mounted on a drive (not shown) so that this program stored in the removable medium can be read and installed into the storage unit 331.

Alternatively, this program can be provided via a wired or wireless transmission medium such as a local area network, the Internet, or digital satellite broadcasting. For example, in each of the devices such as the library terminal device 111, the library server 112, the mobile book-reading account server 113, the terminal device 114, and the bookselling server 115, this program can be received by the communication unit 134, and be installed into the storage unit 133. Also, in the IC tag reader 312, for example, this program can be received by the wireless communication unit 333 or the wire communication unit 335, and be installed into the storage unit 331. Further, in the IC tag 311, for example, this program can be received by the wireless communication unit 323, and be installed into the storage unit 321.

Also, this program may be installed in advance. For example, in each of the devices such as the library terminal device 111, the library server 112, the mobile book-reading account server 113, the terminal device 114, and the bookselling server 115, this program can be installed beforehand into the storage unit 133, the ROM 122, or the like. Also, in the IC tag reader 312, for example, this program can be installed beforehand into the storage unit 331. Further, in the IC tag 311, for example, this program can be installed beforehand into the storage unit 321.

It should be noted that the program to be executed by a computer may be a program for performing processes in chronological order in accordance with the sequence described in this specification, or may be a program for performing processes in parallel or performing a process when necessary, such as when there is a call.

Also, in this specification, steps describing a program recorded on a recording medium include processes to be performed in parallel or independently of one another if not necessarily in chronological order, as well as processes to be performed in chronological order in accordance with the sequence described herein.

Also, the procedures in the respective steps described above may be carried out in each of the above described devices or any appropriate device other than the above described devices. In that case, the device that is to carry out the processes should have the above described functions (functional blocks and the like) necessary for carrying out the processes. Also, the information necessary for carrying out the processes should be transmitted to the device as appropriate.

It should be noted that, in this specification, a system means an assembly of components (devices, modules (parts), and the like), and not all the components need to be provided in the same housing. In view of this, devices that are housed in different housings and are connected to one another via a network form a system also form a system, and one device having modules housed in one housing is also a system.

Furthermore, any configuration described above as one device (or one processing unit) may be divided into two or more devices (or processing units). Conversely, any configuration described above as two or more devices (or processing units) may be combined into one device (or processing unit). Furthermore, it is of course possible to add components other than those described above to the configuration of any of the devices (or processing units). Furthermore, some components of a device (or processing unit) may be incorporated into the configuration of another device (or processing unit) as long as the configuration and the functions of the system as a whole will remain substantially the same.

While preferred embodiments of the present disclosure have been described above with reference to the accompanying drawings, the technical scope of the present disclosure is not limited to those examples. It is apparent that those who have ordinary skills in the technical field of the present disclosure can make various changes or modifications within the scope of the technical spirit claimed herein, and it should be understood that those changes or modifications are within the technical scope of the present disclosure.

For example, the present technology can be embodied in a cloud computing configuration in which one function is shared among devices via a network, and processing is performed by the devices cooperating with one another.

Also, the respective steps described with reference to the above described flowcharts can be carried out by one device or can be shared among devices.

Further, in a case where more than one process is included in one step, the processes included in the step can be performed by one device or can be shared among devices.

The present technology is not limited to this, and can also be embodied as any configuration to be mounted on the above devices or devices in the systems, such as a processor serving as a system large scale integration (LSI) or the like, a module using processors or the like, a unit using modules or the like, and a set (or a configuration in a device) having other functions added to the unit.

It should be noted that the present technology may also be embodied in the configurations described below.

(1) An information processing device including:

an acquisition unit that acquires information from another information processing device, the information being related to lending in a lending service of lending out an object;

a generation unit that generates information to be presented to a user by using the lending-related information acquired by the acquisition unit, the information to be presented to the user being related to the lending service; and

an output unit that outputs the information generated by the generation unit and to be presented to the user.

(2) The information processing device of (1), wherein the output unit outputs the information to be presented to the user, without a request of the user.

(3) The information processing device of (1) or (2), further including

a storage unit that stores the lending-related information acquired by the acquisition unit,

wherein the generation unit generates the information to be presented to the user, using the lending-related information stored in the storage unit.

(4) The information processing device of any of (1) to (3), wherein the information to be presented to the user includes check-out information indicating the object currently lent to the user.

(5) The information processing device of any of (1) to (4), wherein the information to be presented to the user includes check-out history information indicating the user's history of usage of the lending service.

(6) The information processing device of any of (1) to (5), wherein the information to be presented to the user includes return notification information prompting returning of the object currently lent out.

(7) The information processing device of any of (1) to (6), wherein the information to be presented to the user includes recommendation notification information recommending the predetermined object.

(8) The information processing device of (7), further including

a purchasing unit that performs processing related to purchasing of the object, in accordance with the recommendation notification information.

(9) The information processing device of (7) of (8), further including

a reservation unit that performs processing related to reservation of the object, in accordance with the recommendation notification information.

(10) The information processing device of any of (1) to (9), wherein the information to be presented to the user includes lendability notification information indicating that the object reserved by the user can be lent out.

(11) The information processing device of any of (1) to (10), wherein the lending-related information is check-out information about a plurality of users, the check-out information indicating the objects currently lent to the users.

(12) An information processing method including:

acquiring information from another information processing device, the information being related to lending in a lending service of lending out an object;

generating information to be presented to a user by using the acquired lending-related information, the information to be presented to the user being related to the lending service; and

outputting the generated information to be presented to the user.

(13) A program for causing a computer to function as:

an acquisition unit that acquires information from another information processing device, the information being related to lending in a lending service of lending out an object;

a generation unit that generates information to be presented to a user by using the lending-related information acquired by the acquisition unit, the information to be presented to the user being related to the lending service; and

an output unit that outputs the information generated by the generation unit and to be presented to the user.

(14) An information processing device including:

an acquisition unit that acquires information related to lending in a lending service of lending out an object;

a generation unit that generates information to be presented to a user of another information processing device by using the lending-related information acquired by the acquisition unit, the information to be presented to the user being related to the lending service; and

a supply unit that supplies the another information processing device with the information generated by the generation unit and to be presented to the user.

(15) The information processing device of (14), wherein the information to be presented to the user includes return notification information prompting returning of the object currently lent out.

(16) The information processing device of (14) or (15), wherein the information to be presented to the user includes recommendation notification information recommending the predetermined object.

(17) The information processing device of any of (14) to (16), wherein the information to be presented to the user includes lendability notification information indicating that the object reserved by the user can be lent out.

(18) The information processing device of any of (14) to (17), further including

a storage unit that stores the lending-related information,

wherein the acquisition unit acquires the lending-related information from the storage unit.

(19) An information processing system including

a server and a terminal device,

the server including:

a first acquisition unit that acquires information related to lending in a lending service of lending out an object;

a first generation unit that generates recommendation notification information recommending the predetermined object, using the lending-related information acquired by the first acquisition unit; and

a supply unit that supplies the terminal device with the recommendation notification information generated by the first generation unit,

the terminal device including:

a second acquisition unit that acquires the recommendation notification information from the server;

a second generation unit that generates information to be presented to a user, using the recommendation notification information acquired by the second acquisition unit; and

an output unit that outputs the information generated by the second generation unit and to be presented to the user.

### REFERENCE SIGNS LIST

100 Book lending service system
101 Library
102 Mobile book-reading account service provider
103 User
104 Bookseller
110 Network
111 Library terminal device
112 Library server
113 Mobile book-reading account server
114 Terminal device
115 Bookselling server
121 CPU
122 ROM
123 RAM
124 Bus
130 Input/output interface
131 Input unit
132 Output unit
133 Storage unit
134 Communication unit
135 Drive
136 Removable medium
141 Check-out processing unit
142 Return processing unit
151 User management unit
152 Check-out information management unit
153 Book information management unit
154 Reservation information management unit
155 User database
156 Check-out information database
157 Book information database
158 Reservation information database
161 Bookselling processing unit
162 Book database
171 User management unit
172 Application delivery unit
173 Check-out information processing unit
174 Check-out history information processing unit
175 Return notification processing unit
176 Recommendation notification processing unit
177 Reservation notification processing unit
181 User database
182 Lending information database
183 Book information database
184 Reservation information database
191 User registration unit
192 Check-out information processing unit
193 Check-out history information processing unit
194 Return notification processing unit
195 Recommendation notification processing unit
196 Book purchase processing unit
197 Reservation processing unit
201 Check-out information viewing image
202 Check-out history information viewing image
203 Return notification information viewing image
204 and 205 Recommendation notification information viewing image
206 Bookselling image
211 and 212 Lendability notification information viewing image
300 Book lending service system
301 Book
311 IC tag
312 IC tag reader
321 Storage unit
322 Information processing unit
323 Wireless communication unit
324 Antenna
331 Storage unit
332 Information processing unit
333 Wireless communication unit
334 Antenna
335 Wire communication unit
341 Book information supply unit
342 Book information storage unit
351 Book detection unit
352 Notification processing unit
361 Book information processing unit
362 Check-out processing unit
363 Return processing unit
371 Book location check unit
372 Check-out processing unit
373 Return processing unit
381 Check-out reception image
382 Return reception image
400 Book lending service system
411 Two-step authentication processing unit
412 Mobile book-reading account service delivery unit
421 User registration unit
422 Two-step authentication processing unit
423 Mobile book-reading account service using unit
424 Terminal information storage unit

1. An information processing device comprising:
an acquisition unit configured to acquire information from another information processing device, the information being related to lending in a lending service of lending out an object;
a generation unit configured to generate information to be presented to a user by using the lending-related information acquired by the acquisition unit, the information to be presented to the user being related to the lending service; and
an output unit configured to output the information generated by the generation unit and to be presented to the user.

2. The information processing device according to claim 1, wherein the output unit outputs the information to be presented to the user, without a request of the user.

3. The information processing device according to claim 1, further comprising
a storage unit configured to store the lending-related information acquired by the acquisition unit,
wherein the generation unit generates the information to be presented to the user, using the lending-related information stored in the storage unit.

4. The information processing device according to claim 1, wherein the information to be presented to the user includes check-out information indicating the object currently lent to the user.

5. The information processing device according to claim 1, wherein the information to be presented to the user includes check-out history information indicating the user's history of usage of the lending service.

6. The information processing device according to claim 1, wherein the information to be presented to the user includes return notification information prompting returning of the object currently lent out.

7. The information processing device according to claim 1, wherein the information to be presented to the user includes recommendation notification information recommending the predetermined object.

8. The information processing device according to claim 7, further comprising
a purchasing unit configured to perform processing related to purchasing of the object, in accordance with the recommendation notification information.

9. The information processing device according to claim 7, further comprising
a reservation unit configured to perform processing related to reservation of the object, in accordance with the recommendation notification information.

10. The information processing device according to claim 1, wherein the information to be presented to the user includes lendability notification information indicating that the object reserved by the user can be lent out.

11. The information processing device according to claim 1, wherein the lending-related information is check-out information about a plurality of users, the check-out information indicating the objects currently lent to the users.

12. An information processing method comprising:
acquiring information from another information processing device, the information being related to lending in a lending service of lending out an object;
generating information to be presented to a user by using the acquired lending-related information, the information to be presented to the user being related to the lending service; and
outputting the generated information to be presented to the user.

13. A program for causing a computer to function as:
an acquisition unit configured to acquire information from another information processing device, the information being related to lending in a lending service of lending out an object;
a generation unit configured to generate information to be presented to a user by using the lending-related information acquired by the acquisition unit, the information to be presented to the user being related to the lending service; and
an output unit configured to output the information generated by the generation unit and to be presented to the user.

14. An information processing device comprising:
an acquisition unit configured to acquire information related to lending in a lending service of lending out an object;
a generation unit configured to generate information to be presented to a user of another information processing device by using the lending-related information acquired by the acquisition unit, the information to be presented to the user being related to the lending service; and
a supply unit configured to supply the another information processing device with the information generated by the generation unit and to be presented to the user.

15. The information processing device according to claim 14, wherein the information to be presented to the user includes return notification information prompting returning of the object currently lent out.

16. The information processing device according to claim 14, wherein the information to be presented to the user includes recommendation notification information recommending the predetermined object.

17. The information processing device according to claim 14, wherein the information to be presented to the user includes lendability notification information indicating that the object reserved by the user can be lent out.

18. The information processing device according to claim 14, further comprising
a storage unit configured to store the lending-related information,
wherein the acquisition unit acquires the lending-related information from the storage unit.

19. An information processing system comprising
a server and a terminal device,
the server including:
a first acquisition unit configured to acquire information related to lending in a lending service of lending out an object;
a first generation unit configured to generate recommendation notification information recommending the predetermined object, using the lending-related information acquired by the first acquisition unit; and
a supply unit configured to supply the terminal device with the recommendation notification information generated by the first generation unit,
the terminal device including:
a second acquisition unit configured to acquire the recommendation notification information from the server;
a second generation unit configured to generate information to be presented to a user, using the recommendation notification information acquired by the second acquisition unit; and
an output unit configured to output the information generated by the second generation unit and to be presented to the user.
